(19) United States
(12) Patent Application Publication
(10) Pub. No.: US 2024/0324527 A1
(43) Pub. Date: Oct. 3, 2024

(54) WATER FLOW DATA BASED IRRIGATION CONTROL

(71) Applicant: Rain Bird Corporation, Azusa, CA (US)

(72) Inventors: John E. Price, Tucson, AZ (US); Randy R. Montgomery, Tucson, AZ (US); James R. Harris, Tucson, AZ (US); Sean Fayazi-Azad, Tucson, AZ (US); Joseph G. Porrazzo, JR., Sahuarita, AZ (US); Steven M. Barendt, Leander, TX (US)

(21) Appl. No.: 18/620,947

(22) Filed: Mar. 28, 2024

Related U.S. Application Data
(60) Provisional application No. 63/455,213, filed on Mar. 28, 2023.

(51) Int. Cl. A01G 25/16

(52) U.S. Cl. CPC A01G 25/165

(57) ABSTRACT

Systems, apparatuses, and methods are provided herein related to irrigation control. In some embodiments, a shared network of sensors gathers data, and then the data and/or analysis decisions are shared with irrigation devices at other properties. In some embodiments, non-irrigation water flow usage data at a given property can be used to optimize irrigation at the property. In some embodiments, non-irrigation water flow data is used to determine that more than one irrigation station can be run at the same time. In some embodiments, consent can be provided to a water authority for irrigation at a property to be controlled by irrigation schedules and/or schedule adjustments provided by the water authority. And in some embodiments, irrigation can be controlled or adjusted based on analysis of imagery data obtained at a site or property as irrigation is occurring.

### CROSS-REFERENCE TO RELATED APPLICATIONS

This application claims the benefit of U.S. Provisional Application No. 63/455,213 (Attorney Docket No. 8473-157003-US) filed Mar. 28, 2023, which is incorporated herein by reference in its entirety.

### TECHNICAL FIELD

The invention relates generally to irrigation control.

### BACKGROUND

Water is a valuable resource, and its conservation remains a critical concern for a broad spectrum of stakeholders, including governments, water authorities, municipalities, farms, corporations, and consumers. Typically, water is delivered to users or designated properties through a network of conduits, the capacities of which are inherently finite. As such, optimizing the temporal allocation of water usage is important. Additionally, municipalities, water districts, and other agencies that supply water to consumers sometimes regulate the distribution of water in attempts to conserve water, reduce water usage, maintain water reserves as well as for numerous other reasons.

### BRIEF DESCRIPTION OF DRAWINGS

Disclosed herein are embodiments of systems, apparatuses, methods user interfaces, and controls relating to programming irrigation controllers. This description includes drawings, wherein:

FIGS. 1A-1B are simplified diagrams illustrating various examples of an irrigation system in accordance with some embodiments.

FIGS. 1C-1F are simplified block diagrams illustrating various irrigation systems in accordance with some embodiments.

FIGS. 2A-2C are simplified diagrams illustrating various examples of an irrigation system in accordance with some embodiments.

FIG. 3 illustrates a flow meter in accordance with some embodiments.

FIG. 4A illustrates a cross-sectional view of the flow meter FIG. 3 in accordance with some embodiments.

FIG. 4B illustrates a cross-sectional view of an alternative flow meter of FIG. 3 in accordance with some other embodiments.

FIG. 5 is a simplified block diagram of an irrigation system in accordance with some embodiments.

FIGS. 6-8 illustrate various example irrigation systems used in multiple properties in accordance with some embodiments.

FIGS. 9-11 illustrate various example irrigation systems in accordance with some embodiments.

FIG. 12 is a simplified block diagram of a data analysis unit in accordance with some embodiments.

FIG. 13 is an exemplary system for use in implementing methods, techniques, devices, apparatuses, systems, servers, sources and providing control over irrigation, in accordance with some embodiments.

FIGS. 14-19 depict flow diagrams illustrating various example methods for controlling irrigation according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, devices, and methods are provided herein useful to control irrigation. For example, in some embodiments, irrigation control is provided using shared network/s of sensors, e.g., where sensor data is gathered from one site or property, analyzed, and then the data and/or decisions from the analysis are shared with irrigation devices at one or more other sites or properties. In some embodiments, water flow data corresponding to non-irrigation water use is obtained at a given property and used to optimize irrigation at the property. In some embodiments, non-irrigation water flow data is obtained at a property and used to determine that more than one irrigation station can be run at the same time. In some embodiments, consent can be provided to water authority for irrigation at a property to be controlled by irrigation schedules and/or schedule adjustments provided by the water authority in exchange for a reduction of an obligation to the water authority. And in some embodiments, irrigation can be controlled or adjusted based on analysis of imagery data obtained at a site or property as irrigation is occurring.

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the invention. Thus, appearances of the phrases “in one embodiment,” “in an embodiment,” “in some embodiments”, “in some implementations”, and similar language throughout this specification may, but do not necessarily, all refer to the same embodiment.

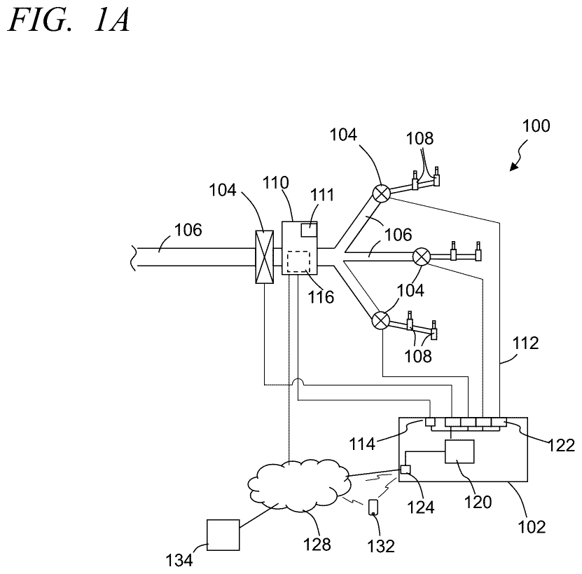

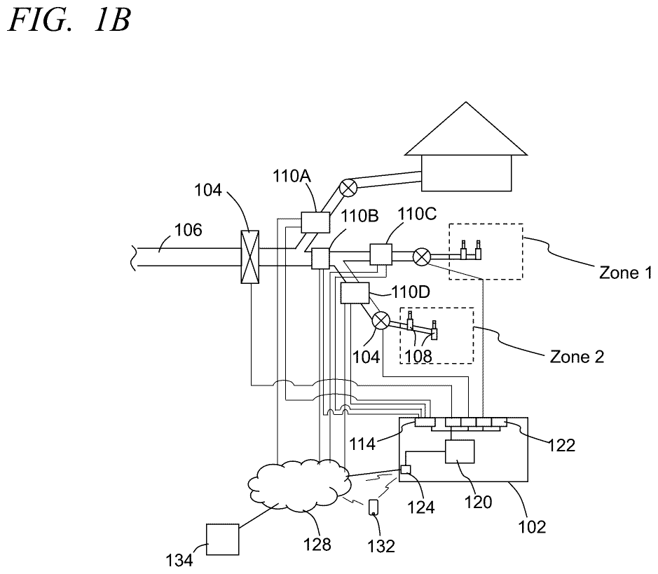

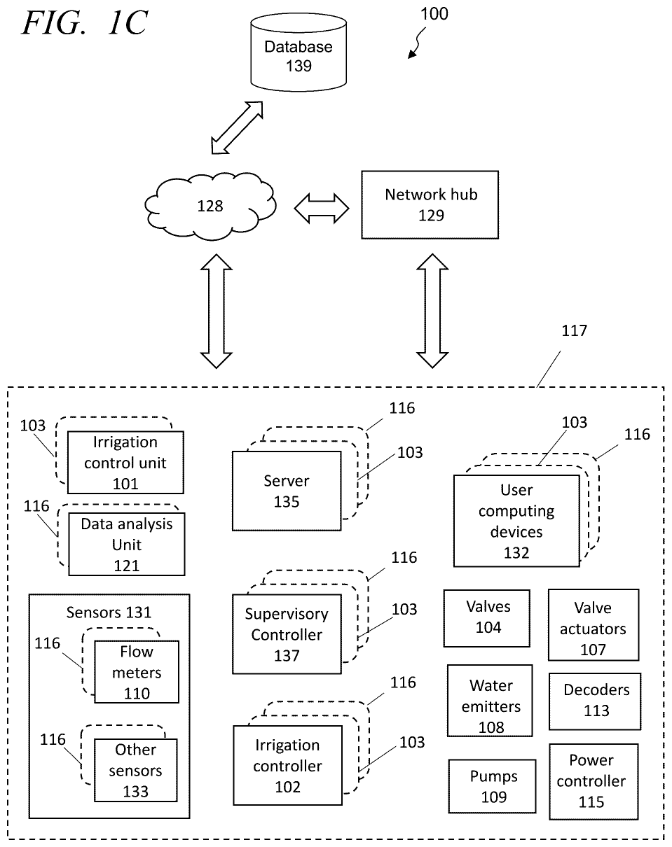

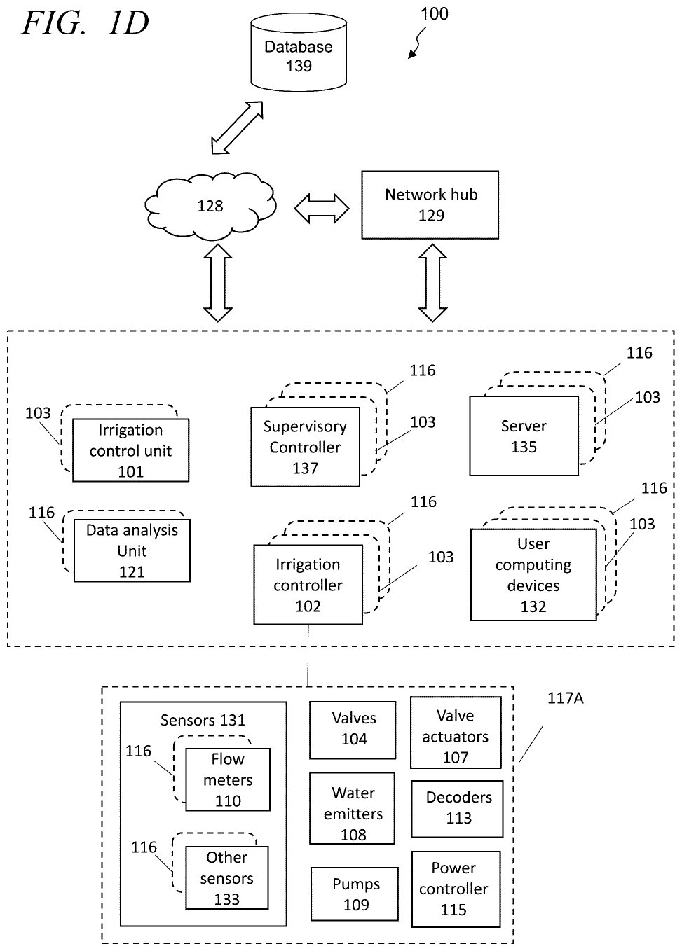

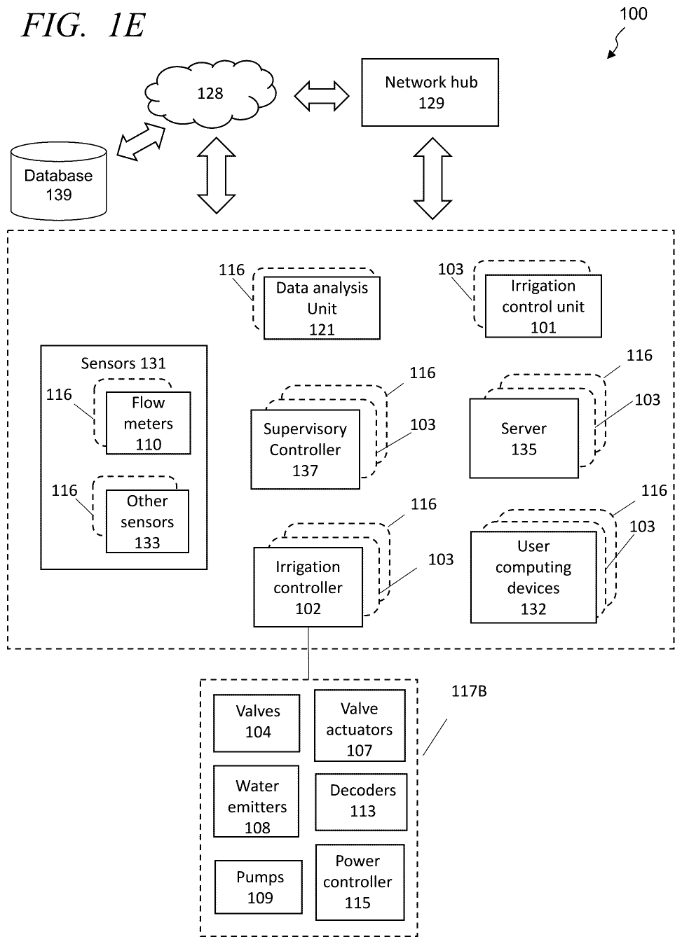

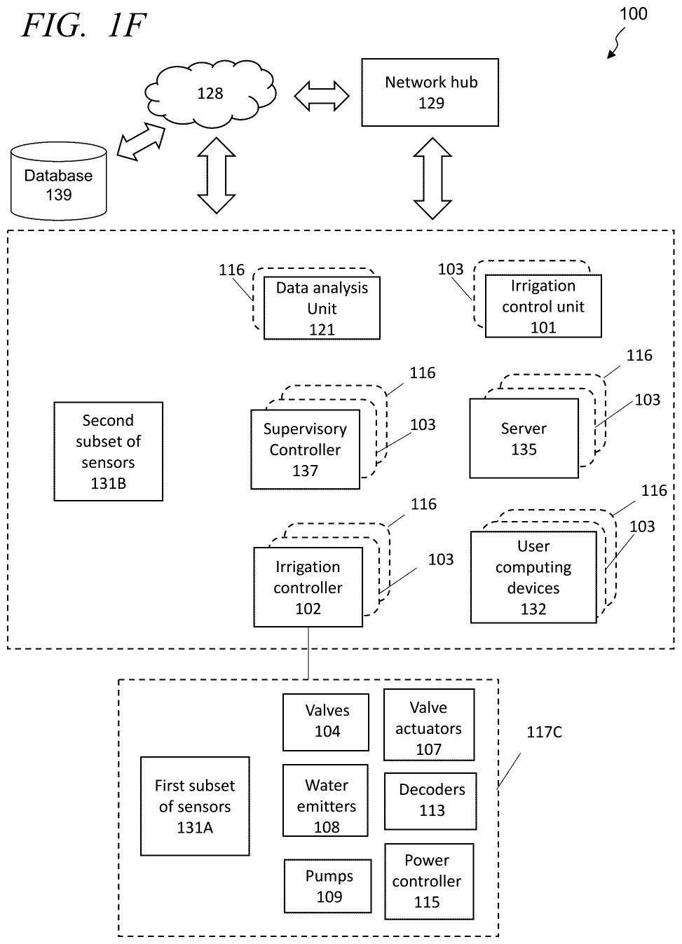

FIGS. 1A-1B show simplified diagrams of exemplary irrigation systems, in accordance with some embodiments. The irrigation system 100 may include one or more irrigation controllers 102, control modules or other such control devices that electrically and/or communicatively couple with one or more valves 104 cooperated with irrigation conduit 106, pipes or the like that are configured to carry water, nutrients and/or other such fluids from one or more water sources (not shown) to one or more water emitters 108 (e.g., sprinklers, drip lines, water hoses, etc.) and/or the one or more water emitters 108, in accordance with some embodiments. Each of the one or more irrigation controllers 102 couple with one or more irrigation valves 104 over controller output or activation lines 112, each coupled to a valve controller cooperated with at least one corresponding valve, which is often located in the region to be irrigated, an electrical switch to activate or deactivate other irrigation devices (e.g., pumps, drain systems, etc.) and/or non-irrigation devices (e.g., lighting or other devices) controlled by the irrigation controller 102. Each valve 104 can cooperate with one or more irrigation conduits 106 to control the flow of water to one or more water emitters 108 (e.g., sprinkler devices, drip lines, and/or other irrigation devices).

The irrigation controller 102 (which can be referred to as an irrigation control unit) is configured to control one or more valves 104 in controlling the flow of water through the irrigation system in implementing and controlling irrigation to plant life within one or more irrigation areas. Typically, the irrigation controller 102 controls the valves 104 in accordance with one or more irrigation schedules. In some embodiments, the irrigation controller 102 includes one or more control circuits 120 that couple with one or more drive circuits 122 and control the activation of the drive circuits 122. The plurality of valves 104 can be communicatively coupled with at least one of the plurality of drive circuits 122 and controlled by the activation of the corresponding one of the drive circuits 122. Again, each of the plurality of valves 104 is typically cooperated with one of multiple different fluid conduits 106 through which water passes, with the plurality of irrigation distribution devices or emitters 108 fluidly cooperated with one of the plurality of fluid conduits. The irrigation distribution devices are configured to distribute water over a corresponding portion of an area to be irrigated.

The irrigation system 100 further includes one or more water flow measuring device 110. The water flow measuring device 110 can be substantially any device that can output an indication corresponding to or that can be used to determine water usage and/or rate of water flow and can measure water usage and/or consumption at the property or irrigation site, and can measure in units of volume, volume per unit of time, a flow rate or other such measurements. For example, the water flow measuring device 110 can include a water meter, a flow meter, a flow sensor, a valve with a measurement capability (e.g., a valve with an internal flow meter), and/or other devices that provide information that can be utilized to determine a volumetric consumption or flow rate. For simplicity, the below description may refer to the water flow measurement device 110 as a flow meter, a meter, or a flow sensor. It will be understood, however, that the meter 110 is not limited to a water meter but can be other devices or a combination of devices that can provide information utilized in determining water consumption and/or usage.

In some embodiments, the flow meter 110 may be communicatively coupled via wired and/or wireless communication with the irrigation controller 102. The flow meter 110 is configured to detect the flow of the water through the conduit 106 and communicate flow data to the irrigation controller 102 for use in controlling the irrigation over the irrigation area. In some embodiments, the irrigation controller 102 is configured to control irrigation based on water flow data, which in some instances may include modifying or interrupting the execution of one or more watering schedules according to several embodiments. In some embodiments, water flow data is used to supplement irrigation control based on programming irrigation scheduling, e.g., to limit, shift or adjust scheduled watering.

Although FIG. 1A shows a single flow meter 110, it is noted, that the irrigation system can include any relevant number of flow meters 110. In some embodiments, a single flow meter 110 is cooperated with a conduit 106. In some implementations, however, more than one flow meter 110 can be cooperated with a single conduit. This may be advantageous for long conduits and/or conduits having numerous irrigation distribution devices or emitters 108 and/or sub-branches of additional conduits 106 along a length of the conduit. For example, each flow meter 110 may be cooperated with each sub-branch of the conduit to detect the flow of water through the sub-branches of the conduit.

Referring to FIG. 1B, in some embodiments, the flow meter 110A may be cooperated with a branch of the conduit corresponding to non-irrigation water supply (e.g., the branch corresponding to indoor water supply, in-office water supply, in-home water supply, and so on) for non-irrigation water usage. With the flow meter 110A cooperated with the non-irrigation water supplying branch of the conduit 106, the flow meter 110A may detect and/or measure the non-irrigation water flow data. In some embodiments, the flow meter 110B may be cooperated with a branch of the conduit corresponding to an outdoor water supply for irrigation water uses and/or outdoor non-irrigation water use. In some embodiments, the outdoor water supply may correspond to the irrigation water supply. In some embodiments, the property or the irrigation area of the property may include a plurality of irrigation zones (also referred to as stations) and each of a plurality of flow meters 110C, 110D may be cooperated with each branch of the conduit corresponding to each of the plurality zones. In some embodiments, the irrigation system 100 may include one or more of the flow meter 110 cooperated with the conduit 106 for the entire property water supply, the flow meter 110A cooperated with the branch of the conduit corresponding to the outdoor water supply, the flow meter 110B cooperated with the branch of the conduit corresponding to the outdoor water supply, the flow meter 110C, 110D cooperated with the branch of the conduit corresponding to the irrigation zone/station. In this description, one or more flow meters 110, 110A, 110B, 110C, 110D may be collectively and representatively referred to as a flow meter 110 or flow meters 110.

In some implementations, the flow meter 110 may provide a hardwire coupling with the irrigation controller 102. In other embodiments, the flow meter 110 includes one or more transceiver 111 (which could be a transmitter) (FIG. 1A) that wired and/or wirelessly transmits water flow data to the irrigation controller 102 and/or other components/devices communicatively coupled with the flow meter 110 via wired and/or wireless communication and/or computer networks 128. In some embodiments, the flow meter 110 is connected to one or more irrigation controller interfaces 114 (e.g., flow sensor input, a rain sensor input, etc.) of the irrigation controller 102.

Further, the irrigation controller 102, in some embodiments, may include one or more wired and/or wireless transceivers 124. The transceiver 124 can allow the irrigation controller 102 to wired and/or wirelessly communicate over one or more computer and/or communications networks 128 with other components, such as but not limited to, one or more user computing devices 132 (e.g., smartphone, tablet, computer, laptop, servers, routers, gateways, etc.), one or more sensors 131 (FIG. 1C), which can be local at the irrigation site where the irrigation system 100 is implemented or remote from the irrigation site, a weather service server 134, a server 135 (FIG. 1C), other third party servers, other such components, or a combination of two or more of such components. In some embodiments, the one or more sensors 131 may be at related areas of the irrigation site (for example, an area adjacent to the irrigation site, or an area in a common geographic area).

The property or irrigation site being irrigated can be substantially any property or site, such as a residence, a commercial site, a school, a park, a golf course, a housing development, and/or other such property.

In some embodiments, referring to FIG. 1A, the irrigation system 100 may include a data analysis unit 121 comprising a data analysis module 116 that may analyze data (e.g., the flow data metered by the flow meter). The data analysis module 116 may analyze the flow data to detect or determine factors, or phenomena related to irrigation according to the features described in detail below.

In some embodiments, the data analysis module 116 may be a part of the flow meter as shown in FIG. 1A. For example, the code for the data analysis module 116 may be stored in a memory device of the flow meter 110 and executed by a control circuit of the flow meter. In some embodiments, the irrigation controller 102 may receive the analyzed flow data analyzed from the flow meter 110.

FIGS. 1C-1F are simplified block diagrams illustrating various irrigation systems in accordance with some embodiments.

Referring to FIG. 1C, in some embodiments, the irrigation system 100 may comprise one or more irrigation control unit 101 comprising an irrigation control module 103 configured to control irrigation. The irrigation control unit 101 may be electrically and/or communicatively coupled with other irrigation system components 117. Any device or component that comprises the irrigation control module 103 may be the irrigation control unit 101, or the irrigation control unit 101 may be a part of the device/component comprising the irrigation control module 103. For example, the code for the irrigation control module 103 may be stored in a memory device of one of the devices or components of the irrigation system 100 and executed by a control circuit of the one of the devices or components of the irrigation system 100. In some embodiments, the irrigation control unit 101 may be a separate unit. In some embodiments, at least one of the irrigation controller 102, server 135, user computing device 132, and/or a supervisory irrigation controller 137 may include the irrigation control module 103, and these one or more devices/components including the irrigation control module 103 may be the irrigation control unit 101, and/or the irrigation control unit 101 may be a part of these one or more device/components including the irrigation control module 103. The irrigation control unit 101 may output signals to implement the irrigation schedule or cause the change/adjustment to the existing irrigation schedule. For example, the irrigation control unit 101 may output signals to activate and/or deactivate the one or more valves 104 or the one or more water emitters 108 and/or to control other irrigation implementing components 117.

In some embodiments, the irrigation system 100 may comprise one or more data analysis unit 121 comprising a data analysis module 116 configured to analyze data such as irrigation related data. The data analyzed by the data analysis module 116 may include, but not be limited to, water flow data collected via the flow meter 110, sensor data collected via the one or more sensors 131, past/previous irrigation schedules, existing/current irrigation schedules, data from a third-party server (e.g., weather data from a weather server), data provided by a user, and so on. In some embodiments, the data analysis module 116 may be further configured to determine an irrigation schedule (i.e., create an irrigation schedule) and/or determine a change/adjustment to an existing irrigation schedule based on the analyzed data. The one or more data analysis unit 121 may be electrically and/or communicatively coupled with other irrigation system components. Any device or component that comprises the data analysis module 116 may be the data analysis unit 121, or the one or more data analysis unit 121 may be a part of device/component comprising the data analysis module 116. For example, the code for the data analysis module 116 may be stored in a memory device of one of the devices or components of the irrigation system 100 and executed by a control circuit of the one of the devices or components of the irrigation system 100. In some embodiments, the one or more data analysis unit 121 may be a separate/independent unit. In some embodiments, at least one of the irrigation controller 102, server 135, user computing device 132, a supervisory irrigation controller 137, the flow meter 110, or other sensors 133 may include the data analysis module 116 and these one or more devices/components including the data analysis module 116 may be the one or more data analysis unit 121, and/or may comprise the data analysis unit 121 (e.g., the data analysis unit 121 may be a part of these one or more device/components including the data analysis module 116). The one or more data analysis unit 121 may output signals to implement the irrigation schedule or cause the change to the existing irrigation schedule. In some embodiments, the one or more data analysis unit 121 may output signals to irrigation control unit 101 to provide the irrigation schedule or the changes to the existing irrigation schedule determined by the one or more data analysis unit 121 when the irrigation control unit 101 and one or more data analysis unit 121 are the separate units. In some embodiments, the one or more data analysis unit 121 may output signals to directly activate and/or deactivate the one or more valves 104 and/or the one or more water emitters 108 and/or control other irrigation implementing components 117B (FIG. 1E). In some embodiments, the irrigation control unit 101 and the data analysis unit 121 may be integrated into a single unit. In some embodiments, the data analysis unit 121 may be incorporated into the irrigation control unit 101.

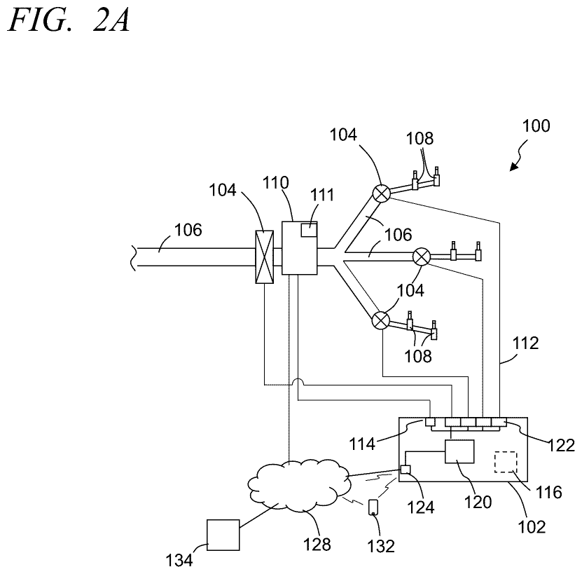

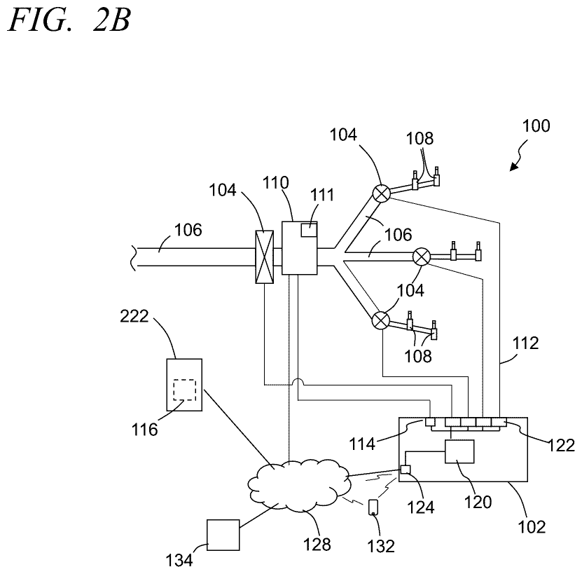

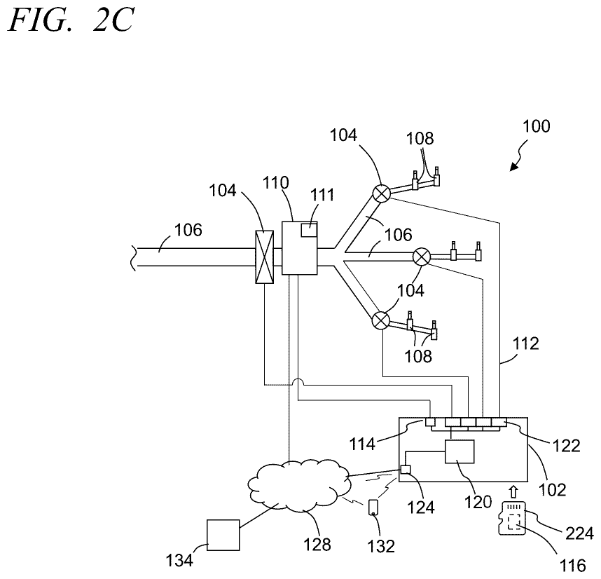

FIGS. 2A-2C are simplified diagrams illustrating various examples of an irrigation system in accordance with some embodiments.

Referring to FIG. 2A, in some embodiments, the data analysis module 116 may be a part of the irrigation controller 102. For example, the code for the data analysis module 116 may be stored in a memory device of the irrigation controller 102 and executed by a control circuit 120 of the irrigation controller 102. In some embodiments, the irrigation controller 102 may receive the water flow data which has not been processed or analyzed and analyze the water flow data.

Referring to FIG. 2B, in some embodiments, the data analysis module 116 may be stored in a separate server 222 which can communicate with both the flow meter 110 and the irrigation controller 102. The flow data server 222 may communicate with the flow meter 110 and the irrigation controller 102 directly or via communications networks 128. In these embodiments, the flow meter 110 may send the measured flow data to the server 222 and the server 222 may process and/or analyze the flow data with the data analysis module 116. The irrigation controller 102 may receive the analyzed data from the server 222. The analyzed data may include any processed irrigation related data, and/or irrigation schedules and/or changes/adjustments to an existing irrigation schedule determined by the data analysis module 116. In some embodiments, the server 222 may be located within or adjacent to the irrigation property. In some embodiments, the server 222 may be a cloud server. In some embodiments, the server 222 may be a part of a central irrigation server.

Referring to FIG. 2C, in some embodiments, the code for the data analysis module 116 may be stored in an external memory 224. The external memory 224 may be accessed and read by the irrigation controller 102 and the code for the data analysis module may be executed by the control circuit 120 of the irrigation controller 120 when the external memory 224 is connected or installed to the irrigation controller. The external memory 224 may be substantially any relevant memory such as, but not limited to, solid-state storage devices or drives, hard drives, one or more of a universal serial bus (USB) stick or drive, flash memory secure digital (SD) card, other memory cards, and other such memory or combinations of two or more of such memory.

In some embodiments, more than one of the irrigation controller 102, the flow meter 110, and the server 222 may include the data analysis module 116. For example, both the irrigation controller 102 and the flow meter 110 may include the data analysis module 116. In other examples, all the irrigation controller 102, the flow meter 110, and the flow data server 222 may include the data analysis module 116. When more than one device includes the data analysis module 116, each device may independently or collaboratively analyze the data.

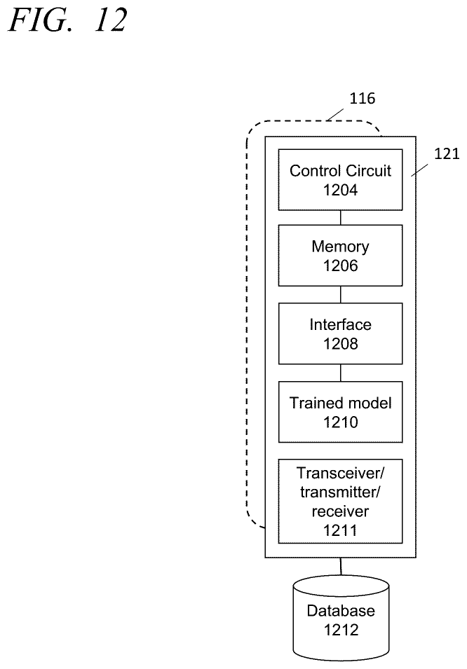

Referring to FIG. 12, in some embodiments, the data analysis unit 121 may comprise a control circuit 1204, a memory 1206, an I/O interface 1208, a transceiver, and an optional trained machine learning model 1210. In some embodiments, the data analysis unit 121 is coupled to one or more databases 1212. The interface 1208 may allow for communications with the communication network 128 and/or individual components of the irrigation system 100 directly or via the communication network 128, gateways, and/or communication hub 129. The interface 208 can include or be an interface to a user interface that will allow users to input irrigation related data.

The control circuit 1204 may comprise a processor, a microprocessor, a central processing unit (CPU), a graphics processing unit (GPU), an application-specific integrated circuit (ASIC), field programmable gate array (FPGA), discrete logic circuits and the like and may be configured to execute computer-readable instructions stored on a computer-readable storage memory 1206 (which may be referred to as a non-transitory storage medium). The computer-readable storage memory 1206 may comprise volatile and/or non-volatile memory and have stored upon it, a set of computer-readable instructions which, when executed by the control circuit 1204, causes the data analysis unit 121 to perform its operations and functions. The trained machine learning model 1210 may be stored in the memory 1206 and executed by the control circuit 1204. Alternatively, the trained machine learning model 1210 may be external and coupled to the data analysis unit 121. The trained machine learning model 1210 may be any known or future model or neural network. Training may be accomplished in known or future ways, and can include supervised or unsupervised learning.

The data analysis unit 121 may include the data analysis module 116 stored on the memory 1206. The data analysis module 116 may conduct, when executed by the control circuit 1204, various steps illustrated below. The data analysis module 116 may be referred to generically as a set of computer-readable instructions or codes stored, encoded, or embedded in a memory 1206 that when executed by a control circuit 1204, perform its functionality.

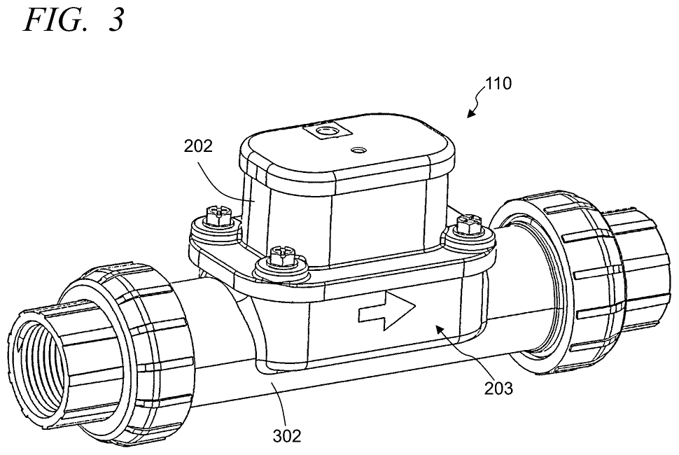

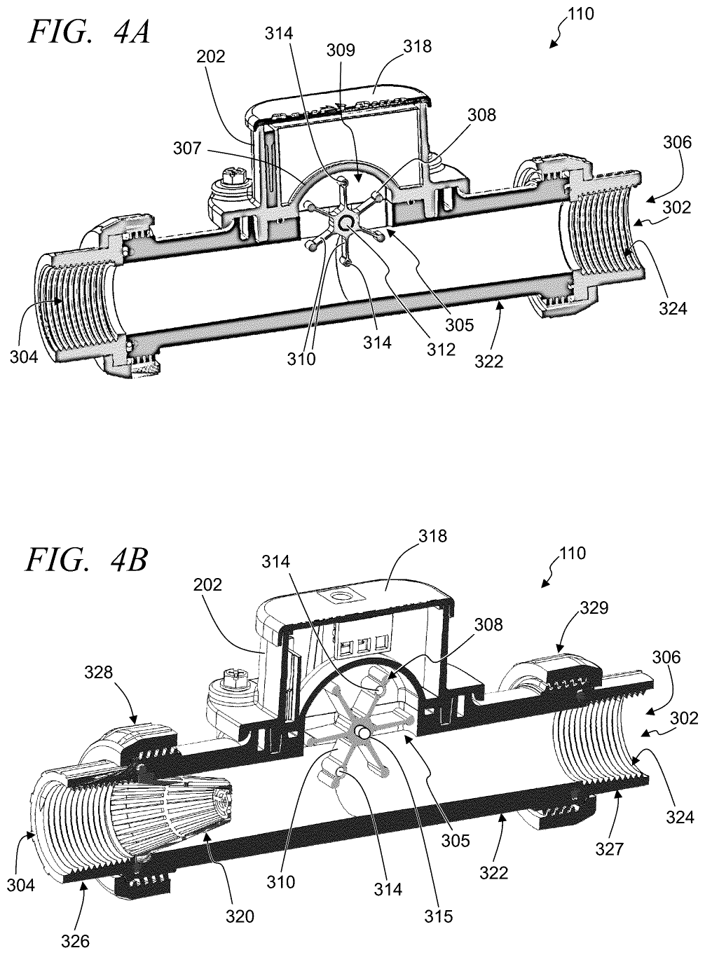

FIG. 3 illustrates an exemplary flow meter 110 in accordance with some embodiments. FIG. 4A illustrates a simplified cross-sectional view of an exemplary flow meter 110 of FIG. 3, in accordance with some embodiments. FIG. 4B illustrates a simplified cross-sectional view of an alternative exemplary flow meter 110 of FIG. 3, in accordance with some other embodiments. As mentioned, the flow meter 110 may be any kind of device that may detect and measure water usage or water flow. Therefore, the flow meter 110 is not limited to the illustration of FIG. 3 and FIGS. 4A and 4B.

Referring to FIGS. 3-4B, the flow meter 110 may include a housing 202 that is secured with a paddle wheel mounting area 203 secured with and/or formed as part of the fluid channel 302 (e.g., screws, bolts, nuts, rivets, epoxy, melt-boding, heat sealing, snap-and-fit, friction, other such methods, or combination of two or more methods), and/or a portion of the housing is formed as part of the fluid channel 302. In some implementations, the housing can define and/or form at least a portion of the fluid channel 302. The fluid channel is configured to transport fluid between a first port 304 and a second port 306. The first port 304 is configured to couple with a first conduit 106 of a fluid path, and the second port 306 is configured to couple with a second conduit 106 of the fluid path of an irrigation system to transport water to irrigation distribution devices or emitters 108 that are each configured to distribute water over one or more geographic areas.

The flow meter 110 further includes a paddle wheel device 308 or other rotational device positioned to be rotated in response to a flow of fluid through the fluid channel 302. In some embodiments, the housing includes a paddle wheel wall 307 that forms a paddle wheel cavity 309 within which the paddle wheel device 308 is positioned and exposes at least a portion of one or more of the blades to the fluid flow through the fluid channel 302. Further, the paddle wheel cavity 309, in some embodiments, is fluidly cooperated with and/or defines part of the fluid channel 302 exposing at least a portion of the paddle wheel to the fluid within the fluid channel 302. In some embodiments, the fluid channel 302 includes a paddle wheel aperture 305 formed in the wall of the fluid channel 302 and is aligned with and configured to cooperate with a portion of the paddle wheel wall 307 to form at least part of the paddle wheel cavity 309. The paddle wheel aperture 305 is formed, in some embodiments, with aperture walls extending away from a conduit portion 322 of the fluid channel 302. The aperture walls can be configured to align with and cooperate with paddle wheel wall 307 and/or a bottom portion of the housing 202. One or more fluid seals, O-rings, gaskets and/or other structures can be utilized to fluidly seal the housing with the fluid channel 302.

Referring back to FIG. 1C, in some embodiments, one or more irrigation system components 117 may communicate with other irrigation system components 117 directly or via communication network 128. The communication network 128 may be any known or future wide-area network (WAN), a local area network (LAN), a personal area network (PAN), a wireless local area network (WLAN), Wi-Fi, Zigbee, Bluetooth (e.g. Bluetooth Classic, Bluetooth Low Energy (BLE) networks) LoRa, LoRaWAN, cellular data networks, or any other public or private internet or intranet network, or combinations of such networks. The one or more irrigation system components 117 (e.g., at least one of the irrigation control unit 101, the irrigation controller 102, the data analysis unit 121, the one or more sensors 131, the server 135, the supervisory irrigation controller 137, the user computing device 132, the one or more valves 104, one or more valve actuators 107, the one or more water emitters 108, one or more decoders 113, one or more pumps 109, one or more power controllers 115) may connected to the communication network 128 directly or via one or more communication hubs 129. The communication hub 129 may include, but not limited to, a gateway, a relay station, a router, and/or a repeater. The communication hub 129 may be owned by the entity who irrigates or uses the property with the irrigation system components 117 (e.g., a user) or be owned by a third-party (e.g., a neighbor). In some embodiments, the communication hub 129 may be a public communication hub. In some embodiments, a user's mobile electronic device (e.g., a smartphone) and/or a third-party's mobile electronic device may be the communication hub 129. In some embodiments, a device having access to the network 128 may have primary function unrelated to the irrigation system but may include hub functionality executed in the background to its primary function to route communications from irrigation components 117 to the other devices via the network 128. For example, a SKYBRIDGE device (such as a home speaker) can be a part of an AMAZON SIDEWALK network and can route data to a server via the network 128 such that the SKYBRIDGE device can function as the network hub 129. AMAZON SIDEWALK and SKYBRIDGE devices are commercially available from Amazon.com, Inc. and their functionality is known in the art.

Generally, communication between various electronic devices of the irrigation system 100 may take place over hard-wired, wireless, cellular, Wi-Fi or Bluetooth networked components or the like. In some embodiments, one or more electronic devices/components of the irrigation system 100 may be realized using cloud-based, physically hosted infrastructure or any combination thereof and the physical infrastructure may be on-premises, remotely hosted or any combination thereof.

Referring to FIG. 1D, in some embodiments, a first subset 117A of the irrigation system components 117 comprising at least one of the sensor 131, the valve 104, the valve actuator 107, the water emitter 108, the decoder 113, the pump 109, or the power controller 115 may communicate via an irrigation controller 102. In some embodiments, the first subset 117A of the irrigation system components 117 may be communicatively coupled to the irrigation controller 102 and communicate with, transmit communications to, or receive communications from other irrigation system components 117 only via the irrigation controller 102. For example, to transmit sensor data collected from the sensor 131 to a server, the sensor 131 may transmit the sensor data only to the irrigation controller 102 and the irrigation controller 102 may transmit the sensor data to the server 135 via the communication network 128 and/or the communication hub 129.

Referring to FIG. 1E, in some embodiments, a second subset 117B of the irrigation system components 117 comprising at least one of the valve 104, the valve actuator 107, the water emitter 108, the decoder 113, the pump 109, or the power controller 115 may communicate via an irrigation controller 102. In some embodiments, the second subset 117B of the irrigation system components 117 may be communicatively coupled to the irrigation controller 102 and communicate with, transmit communications to, or receive communications from other irrigation system components 117 only via the irrigation controller 102. Compared to the embodiments of FIG. 1D, in the embodiments of FIG. 1E, the sensor 131 may communicate with other components independently of the irrigation controller 102. For example, to transmit sensor data collected from the sensor 131 to the server 135, the sensor 131 may transmit the sensor data to the server 135 via the communication network 128 and/or the communication hub 129.

Referring to FIG. 1F, in some embodiments, a third subset 117C of the irrigation system components 117 comprising at least one of a first subset 131A of the sensors 131, valve 104, the valve actuator 107, the water emitter 108, the decoder 113, the pump 109, or the power controller 115 may communicate via an irrigation controller 102. In some embodiments, the third subset 117C of the irrigation system components 117 may be communicatively coupled to the irrigation controller 102 and communicate with, transmit communications to, or receive communications from other irrigation system components 117 only via the irrigation controller 102. A second subset 131B of the sensors 131 may communicate with other components independently of the irrigation controller 102. The first subset 131A of the sensors 131 may be any subset of multiple sensors 131 and the second subset 131B of the sensors 131 may be the remaining sensors of the multiple sensors 131 not being included in the first subset 131A of the sensors 131. For example, the flow meter 110 may communicate with other components independently of the irrigation controller 102 but a rain sensor may only communicate with the irrigation controller 102 such that to transmit rain data collected from the rain sensor to the server 135, the rain sensor may transmit the rain data to the irrigation controller 102 and the irrigation controller 102 may transmit the received the rain sensor to the server 135.

In some embodiments, the one or more sensors 131 can include substantially any relevant sensor, such as but not limited to, a flow meter 110, a soil moisture sensor, a rain sensor, a wind sensor, a humidity sensor, an optical sensor, an acoustic sensor, a sound sensor, a thermal sensor, and other such relevant sensors.

The server 135 may include a local server, a remote server, a central irrigation server, a third party server, and/or a close based server. In some embodiments, the server 135 may be a closed based server providing Software as a Service (Saas) and the irrigation system 100 may use the SaaS to execute or assist in executing the steps of the processes, methods, functionality, and techniques described herein, and control various communications, decisions, programs, content, listings, services, interfaces, logging, reporting, etc.

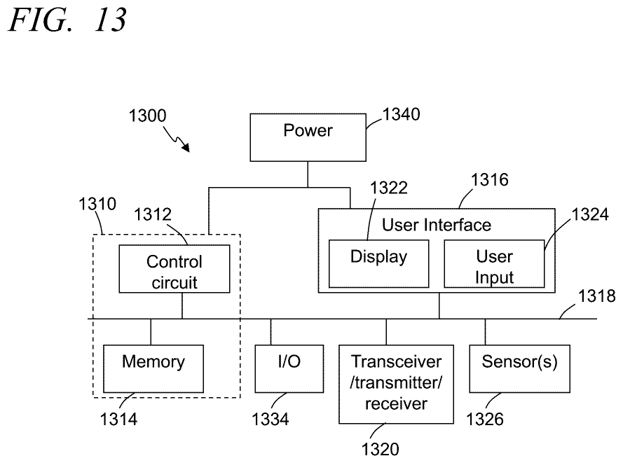

Referring to FIG. 13, in some embodiments, circuits, circuitry, systems, devices, processes, methods, techniques, functionality, services, sources, and the like described herein may be utilized, implemented and/or run on many different types of devices and/or systems. FIG. 13 illustrates an exemplary system 1300 that may be used for implementing any of the components, circuits, circuitry, systems, functionality, apparatuses, processes, or devices of the irrigation system 100 and/or other above or below mentioned systems or devices, or parts of such circuits, circuitry, functionality, systems, apparatuses, processes, or devices. For example, the system 1300 may be used to implement some or all of the irrigation control unit 101, the irrigation controller 102, the data analysis unit 121, the flow meter 110, the sensors 131, the server 135, the supervisory irrigation controller 137, the user computing device 132, the valves 104, the valve actuator 107, the water emitters 108, the decoders 113, the pumps 109, the power controller 115, the weather service server 134, the communication hub 129 and/or other such components, circuitry, functionality and/or devices. However, the use of the system 1300 or any portion thereof is optional.

By way of example, the system 1300 may comprise a control circuit 1312 (e.g., processor), memory 1314, and one or more communication links 1318, paths, buses, or the like. Some embodiments may include one or more user interfaces 1316, and/or one or more internal and/or external power sources or supplies 1340. The control circuit 1312 can be implemented through one or more processors, microprocessors, central processing unit, logic, local digital storage, firmware, software, and/or other control hardware and/or software, and may be used to execute or assist in executing the steps of the processes, methods, functionality, and techniques described herein, and control various communications, decisions, programs, content, listings, services, interfaces, logging, reporting, etc. Further, in some embodiments, the control circuit 1312 can be part of control circuitry and/or a control system 1310, which may be implemented through one or more processors with access to one or more memory 1314 that can store instructions, code, and the like that is implemented by the control circuit and/or processors to implement intended functionality. In some applications, the control circuit and/or memory may be accessed over and/or distributed over a communications network (e.g., LAN, WAN, Internet) providing distributed and/or redundant processing and functionality.

The user interface 1316 can allow a user to interact with the system 1300 and receive information through the system. In some instances, the user interface 1316 includes a display 1322 and/or one or more user inputs 1324, such as buttons, touch screen, trackball, keyboard, mouse, etc., which can be part of or wired or wirelessly coupled with the system 1300. Typically, the system 1300 further includes one or more communication interfaces, ports, transceivers 1320 and the like allowing the system 1300 to communicate over a communication bus, a distributed computer, and/or communication network (e.g., LAN, WAN, Internet, etc.), communication link 1318, other networks or communication channels with other devices and/or other such communications or combination of two or more of such communication methods. Further, the transceiver 1320 can be configured for wired, wireless, optical, fiber optical cable, satellite, or other such communication configurations or combinations of two or more of such communications. Some embodiments include one or more input/output (I/O) ports 1334 that allow one or more devices to couple with the system 1300. The I/O ports can be substantially any relevant port or combinations of ports, such as but not limited to USB, Ethernet, or other such ports. The I/O interface 1334 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 1326. The sensors can include substantially any relevant sensor, such as acoustic or sound sensors, temperature sensors, rain sensors, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 1300 comprises an example of a control and/or processor-based system with the control circuit 1312. Again, the control circuit 1312 can be implemented through one or more processors, controllers, central processing units, logic, software, and the like. Further, in some implementations, the control circuit 1312 may provide multiprocessor functionality.

The memory 1314, which can be accessed by the control circuit 1312, typically includes one or more processor readable and/or computer readable media accessed by at least the control circuit 1312, and can include volatile and/or nonvolatile media, such as RAM, ROM, EEPROM, flash memory and/or other memory technology. Further, the memory 1314 is shown as internal to the control system 1310; however, the memory 1314 can be internal, external or a combination of internal and external memory. Similarly, some or all of the memory 1314 can be internal, external or a combination of internal and external memory of the control circuit 1312. The external memory can be substantially any relevant memory such as, but not limited to, solid-state storage devices or drives, hard drives, one or more of a universal serial bus (USB) stick or drive, flash memory secure digital (SD) card, other memory cards, and other such memory or combinations of two or more of such memory. The memory 1314 can store code, software, executables, scripts, data, patterns, thresholds, lists, programs, log or history data, and the like. While FIG. 13 illustrates the various components being coupled together via a bus, it is understood that the various components may actually be coupled to the control circuit and/or one or more other components directly.

In some embodiments, the flow meter 110 tracks water flow, the volume of the water, the speed of the water, and/or other such measures of water use (e.g., volumetric water use) delivered to the property or irrigation site, where at least a portion of the water passing the water flow meter is distributed by the water emitters 108 of the irrigation system. The metered information is supplied to the irrigation controller 102 and used by the irrigation controller 102 in adjusting the irrigation relative to a volumetric water budget specified for a budget period, where the budget period can be substantially any relevant period and can be time-based, event-based or other such periods. In some instances, the irrigation controller 102 utilizes the metered information to determine whether the water usage has exceeded the budget and/or may further determine in some embodiments whether continued water use is predicted to exceed the water budget during the budget period. In those instances where the irrigation controller determines that water usage has exceeded the water budget and/or anticipates exceeding the volumetric water budget, the irrigation controller 102 takes actions relative to further water use.

In some embodiments, the metered information is supplied to the irrigation controller 102 and used by the irrigation controller 102 in generating a new irrigation schedule. The irrigation controller may create an irrigation schedule for the property based on the metered information and water budget. For example, the irrigation controller may determine the maximum amount of water that can be used for irrigation without exceeding the water budget during the budget period. Then, the irrigation controller may create the irrigation schedule within the determined maximum amount of water that can be used for the irrigation. In creating the irrigation schedule, the irrigation controller may also consider one or more factors such as but not limited to types and the number of water emitters, irrigation zone priority (e.g., user-specified), types of plant life being irrigation through the zone, soil type, ground slop, sensor data (e.g., soil moisture, leaks, etc.), season and weather information, or other such factors or combinations of factors. In some embodiments, the schedule may be automatically generated with or without input from a user. For example, a schedule or program generator may divide the volume of water into multiple watering events having a minimum watering duration and preset ranges of the number of watering events per week (which may change during different seasons). The generator then creates a schedule spreading out watering events and durations over a period of time, such as a week, a month, a season, and so on. Other factors may be considered such as the type of plant life to be irrigated. It is known that some types of plant life require more water than others. User could input one or more of the following data that could be accounted for by the schedule generator: plant life, soil type, shade or sun exposure, desired minimum watering duration, desired watering/non-watering days, desired watering start times, and so on.

In some embodiments, the irrigation system may use water flow data in adjusting irrigation to avoid a failure condition. In some embodiments, the water flow data may be used to detect or predict an impending failure condition and alert a user and/or take preventative corrective action. For example, water flow drift may be detected in a specific zone, and the irrigation controller may control the irrigation system to avoid failure conditions based on the detected flow drift. In some embodiments, the flow drift may refer to the hysteresis phenomenon of water flow in repetitive irrigations. For example, if an irrigation schedule has been set to water for 10 minutes for a first zone, the irrigation controller may control the valve corresponding to the first zone to be open for 10 minutes. From the flow data measured over time, the irrigation system may learn that five gallons of water are generally distributed at the first zone during the scheduled 10 minutes of watering. However, the hysteresis phenomenon may cause deviation in a watering amount such that there may be a difference between the amount of water that the irrigation controller instructs to distribute, and the amount of water actually distributed. In some embodiment, hysteresis may reduce or increase watering amount than the irrigation schedule, and the irrigation system may detect these reductions and increases in watering amount. The cause of hysteresis may vary. For example, hysteresis may occur because of abrasion and/or deformation of water emitters, valves, and/or conduits.

The watering amount or volume is one of the important factors to irrigate plants. Too much watering or too little watering may cause failure in irrigation. To avoid failure, if the detected water flow or volume indicates the watering amount is heading towards a failure condition, the irrigation controller may adjust irrigation to maintain the watering amount (maintain a minimum volume or not exceed a maximum volume) to avoid reaching a failure condition. For example, the irrigation controller may reduce or increase the runtime to maintain the distributed watering amount within the proper range. For example, if the irrigation system detects hysteresis toward the ceiling of the failure condition, the irrigation controller may stop watering earlier or close the master valve when the water flow data indicates the amount of distributed water reaches the scheduled amount.

Further, the irrigation controller may calculate a renewed runtime to offset the hysteresis and meet the scheduled watering amount based on the measured water flow data and update the irrigation schedule accordingly. In some embodiments, when the opening degree of valves is controllable, the irrigation controller may adjust the flow rate by controlling the degree of the valve's opening to offset the hysteresis.

Additionally or alternatively, the irrigation controller may send a notification to a user (e.g., the owner of the property to be irrigated by the irrigation controller) that the irrigation system detects that the actual amount of water distribution is heading toward a failure condition based on the water flow data. The notification may recommend changing or checking valves or other water emitters.

In some embodiments, the irrigation system may determine the type of water emitters based on the water flow data. The water emitters may include but not be limited to a sprinkler, a spray, a rotor, a drip emitter, and/or a flood emitter, for example. Because each water emitter may have a different signature in distributing water in terms of flow rate and/or flow volume, this different signature may affect the water flow and create a unique water flow pattern, and the irrigation system may decide the type of water emitters by analyzing the water flow pattern. In some embodiments, each zone of the property may have different water emitters.

Based on the determined types of water emitters, the irrigation controller may optimize or adjust the irrigation schedule. In some embodiments, the irrigation controller may calculate the optimized runtime based on the determined types of water emitters. For example, if the irrigation system determines that the current irrigation schedule is not enough to water the zone of the property given the determined water emitters and given the detected water flow pattern for the zone, the irrigation controller may increase the irrigation runtime. In adjusting the runtime or in calculating the optimized runtime, the irrigation system may consider, in addition to the type of the water emitters and water flow pattern, one or more factors such as but not limited to estimated water pressure, pipe size, valve size, number of water emitters, weather information, soil moisture condition, and other such factors.

Further, in some embodiments, once the system has determined the emitter types using flow data, the flow data can be further monitored to detect deviations from the expected use of the emitter. For example, if an emitter determined to be a drip emitter begins to show flow use data outside of a drip emitter, this could indicate a failure (e.g., leak, emitter missing, etc.) or that a user has changed the emitter type.

In some embodiments, the flow analysis module and other communicatively connected devices related to the usage of water may share water usage information with each other and/or share the data back to the flow sensor. For example, the data analysis module 116 may receive the water usage information from the irrigation controller.

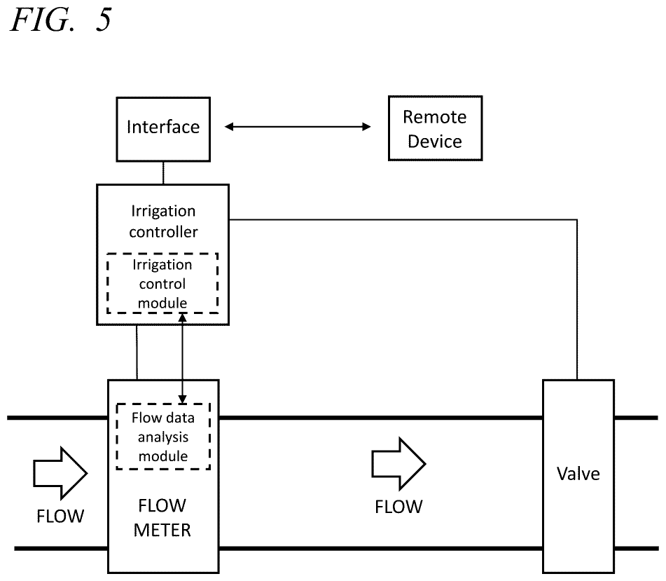

FIG. 5 is a simplified block diagram of an irrigation system in accordance with some embodiments. Referring to FIG. 5, in some embodiments, the irrigation control module of the irrigation controller may share irrigation control information such as information regarding the type of watering, the activation/deactivation of valves, the location of activated/deactivated valves, the labeling of valves, and types of water emitters associated with the activated/deactivated valves. For example, the flow analysis module may receive the information from an irrigation controller that sprinklers in a specific area are running.

In some embodiments, the flow analysis module 116 may use the water usage information received from the irrigation controller in analyzing the measured flow data. The flow analysis module may improve the precision of the analysis by using the shared water usage information. The water usage data information may reduce the number of unknown factors.

In some embodiments, the irrigation control module may send and share the water usage information with the flow analysis module in real time. In other embodiments, the irrigation control module may share the water usage information with a time stamp for each event. In these embodiments, the water usage information created by the irrigation controller may not necessarily need to be shared with the flow analysis module in real time.

In some embodiments, the irrigation controller can respond to the flow meter to provide programming data in advance of or in response to measured or sensed flow data. For example, when the flow meter provides flow data at a specific point in time, the controller can respond to the flow meter that the controller is currently watering valve/station number 2 (as opposed to any of the other stations being controlled by the controller). In this way, the flow meter can associate flow data having a given rate or volume at that point in time as an irrigation use and irrigation of station number 2. In other cases, the controller could respond to the flow meter to indicate that the controller is not attempting to water. The flow meter could assist in determining an alert condition or conclude that the measured or sensed water flow data corresponds to a non-irrigation water use, such as other household uses (laundry, toilet, etc.).

Although FIG. 5, illustrates that the data analysis module is located in the flow meter, as described above, the data analysis module may be included in the irrigation controller or another remote device such as the analysis server. When the data analysis module is included in the irrigation controller, the irrigation control module of the irrigation controller may share the water usage information created by it with the data analysis module.

In some embodiments, the measured flow data may be used to detect occurrences of reverse flow. Conduits for water are generally designed for one-way water flow (typically from the water provider to the water emitters, for example, faucets, sprinklers, rotors, toilets, etc.). However, occasionally reverse flow, which is opposite to the targeted water flow, may occur. For example, when a firefighter connects water to a water supply, the reverse flow may occur at the water conduit near the firefighter's water use as water is being drawn. This reverse flow may damage the water supply system, valves, water emitters, and water emitters. Further, the reverse flow may cause a health risk from the reverse flow of the contaminated water.

In some embodiments, when the reverse flow is detected by the irrigation system, for example, detected by the data analysis module, the irrigation controller may take action to minimize the reverse flow. For example, the controller may isolate the conduit branch where the reverse flow occurs by closing a corresponding valve. Additionally or alternatively, the controller may open all valves affected by the reverse flow to dump water to prevent the water from flowing in the reverse direction. Flow sensors can be designed to detect the flow volume, flow rate and/or the direction of flow. For example, the flow sensor may detect a direction of rotation of the paddlewheels 310 in FIGS. 4A and 4B in addition to the speed of rotation.

In some embodiments, the measured flow data may be used to estimate pipe recharge time. The entire line of a water conduit can ideally be fully filled with water. The irrigation controller generally controls the valves and/or the water emitters with an assumption that the water conduit is filled with water with a proper pressure such that when the controller opens the valves, water is immediately emitted from the water emitter. However, sometimes, the water conduit may not be fully filled with water, when, for example, the watering conduit has a drainage end (or drainage head or drainage opening of the water line) in a relatively lower position; water leakage occurs in a lower position of the water conduit; or the emitter is located at a lower position than supplying water conduit. When the water conduit is not fully filled with water, the actual amount of water emitted may be different from the amount of water according to the watering schedule executed by the irrigation controller since the water conduit is refilled (recharged) during the beginning of the water cycling before the water conduit is pressured.

In some cases, watering from the lower end may drain the conduit of water and then when watering is complete, the conduit needs to re-fill so that the conduit is re-filled and re-pressurized. The time is takes to refill the conduit to normal pressure is referred to as the “recharge time”.

In some embodiments, the flow data from the water meter may be used to detect that the water conduit is not fully filled with water. For example, the data analysis module may detect an unfilled conduit when the water meter does not detect sufficient water flow while the water usage (e.g., watering) is reported by the other device, for instance, as described before. In this case, the duration that the water meter does not detect sufficient water flow while the watering is reported may indicate the recharge time. This situation may occur when the water meter is disposed in front of the unfilled conduit.

In other examples, the data analysis module may also detect an unfilled conduit when the water meter detects water flow but no water is emitted from the water emitter (this may be detected by an image sensor or moisture sensor). In this case, the duration that the water meter detects the water flow, but water emission is not detected may indicate the recharge time. This situation may occur when the conduit between the emitter and the water meter is not filled.

In other examples, the data analysis module may also detect unfilled conduits when the water flow rate is less than usual. The flow meter data can then be used to determine if there is leakage in the conduit, as evidenced by flow data different from the watering from emitters reported or detected by other irrigation devices such as an irrigation controller or sensors.

In some embodiments, when the water meter detects that the water conduit is not fully filled with water (e.g., no flow measured when watering is to occur or flow when watering is not to occur and the conduit is recharged), the irrigation controller may recommend a solution, such as using RAINBIRD®'s SEAL-A-MATICTM (SAM) check valves to solve the issue. The SAM check valves may eliminate low-head water drainage from the water emitter.

In some embodiments, based on the flow data, the data analysis module may estimate or calculate the conduit (water pipe) recharging time. In one aspect, the data analysis module may estimate the general recharging time, which can be applied to most cases. In other aspects, the data analysis module may estimate the case-specific recharging time based on the currently detected water flow rate (including no flow). In some embodiments, the irrigation controller may apply the estimated recharging time to the irrigation schedule. For example, the irrigation controller may add the estimated recharging time to the scheduled time for watering. For example, if the recharge time is 1 minute, then the irrigation controller can be instructed to irrigate for 1 minute longer than scheduled in order that the intended watering time occurs.

In some embodiments, the measured flow data may be used to estimate blowout time. In an irrigation system, the blowout time refers to the time for blowing air into the water conduit to remove some or substantially the entire water from the water conduit. The water conduit blowout is typically conducted to prevent winter damages such as freezing and cracking of the water conduit. Removing too much water from the conduit may cause a waste of water, and failing to remove enough water from the water conduit may not prevent winter damage. In some embodiments, based on the water flow data, the data analysis module may calculate the amount of water filling the water conduit and estimate the optimized blowout time to remove a certain amount of water from the water conduit. For example, the data analysis module may calculate the blowout time to remove 25% of the water from the water conduit associated with the user's property. In calculating the blowout time, the data analysis module may further consider one or more factors such as air pressure to be applied to the water conduit, the type of air compressor, the size and length of the water conduit, and so on. Generally, it is desired to not apply blowout pressure for too long in the irrigation system since it sustained air pressure may damage the rotary components of the water meter.

In some embodiments, the irrigation system may detect a water hammer. For example, the data analysis module may detect water hammer conditions from the water flow data measured by the flow meter. A water hammer (in other words, hydraulic shock) may be caused when water in motion is forced to stop or change direction suddenly and bring a traveling waveform going back and forth in the water conduit. For example, the data analysis module may detect the water hammer from the back-and-forth water flow data. The causes of the water hammer may vary. For example, a water hammer may occur when a valve is closed instantly instead of closing gradually.

The water hammer condition may damage the valves, flow meter, or water emitters. For example, when the flow meter includes a paddle wheel to measure the water flow as shown in FIGS. 4A and 4B, the water hammer may hit and damage the paddle wheel.

In some embodiments, to reduce the damage caused by the water hammer, when the water hammer condition is detected, the irrigation controller may briefly open a valve to relieve the pressure and then close the valve. In addition, the irrigation controller can adjust the valve closing speed during future watering events. For example, the irrigation controller may have the valve close gradually by reducing the valve closing speed. Further, in some embodiments, when the total count of the detected water hammers is greater than a predetermined value or critical value, the irrigation controller may send a notification to the user and/or recommend checking the watering devices such as valves, flow meters, and/or water emitters.

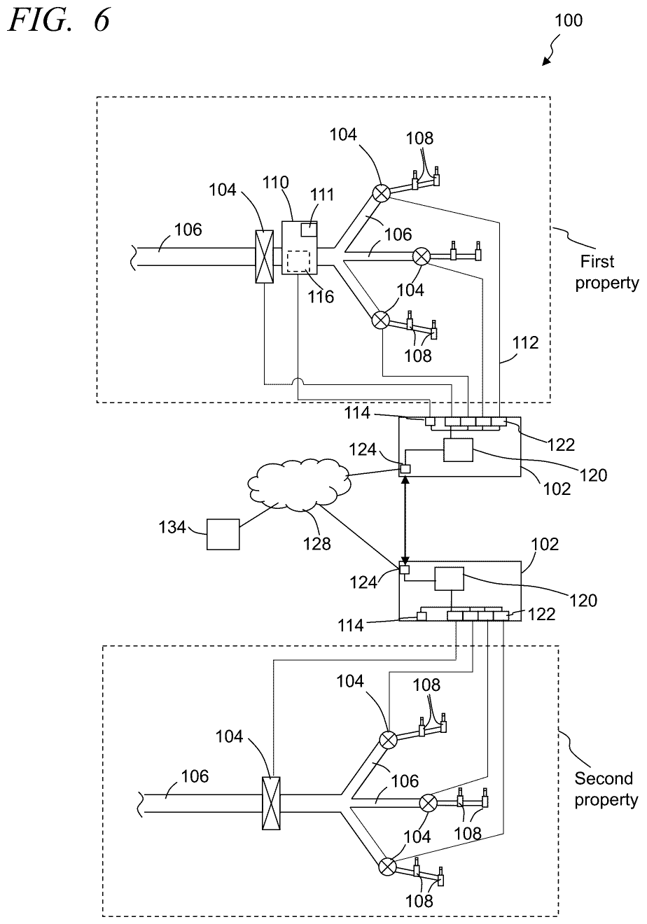

In some embodiments, the irrigation controller may use and apply the water flow data measured from one property (e.g., a first property) to the other property (e.g., a second property). The first and second properties may be adjacent, nearby, or close to each other or otherwise have similar irrigation characteristics. Referring to FIG. 6, the first property is irrigated with an irrigation system including the flow meter 110 and the second property is irrigated with an irrigation system that does not include the flow meter 110. In some embodiments, when the irrigation system for the second property does not include the flow meter, the irrigation controller for the second property may receive and utilize the water flow data from the irrigation system for the first property.

For example, the irrigation controller for the second property may receive the flow data from the irrigation system equipped with the flow meter and use the flow data in adjusting the irrigation schedule of the second property. In one approach, the irrigation controller for the second property may receive the flow data directly from the flow meter of the first property or from the irrigation controller of the first property. In other approaches, the irrigation controller for the second property may receive the analyzed flow data from the data analysis module 116 of the first property.

In some embodiments, the irrigation controller for the second property may receive and apply the irrigation schedule for the first property when the user of the second property wants to apply the irrigation schedule for the first property. The irrigation schedule from the irrigation system for the first property may be an irrigation schedule that has been adjusted based on the flow data of the first property.

If the user of the irrigation system for the second property is different from the user of the irrigation system for the first property, the irrigation controller for the second property can receive the flow data and/or the irrigation schedule adjusted based on the flow data of the first property when the user of the irrigation system for the first property consents to share the information.

Although FIG. 6 illustrates that the irrigation controller for the first property and the irrigation controller for the second property as separate devices, one irrigation controller may control both the first and second properties. In this case, the irrigation controller may use the flow data measured from the first property in adjusting the irrigation schedule of the second property. Further, the first and second properties may be owned or held by the same user or different users. In some embodiments, the first property may be a neighbor property of the second property.

In some embodiments, the irrigation information and/or the water flow data from one or more sources may be shared with each other to help users adjust their irrigation schedule manually or the irrigation system of the users automatically adjust the irrigation schedule. The irrigation information and/or the water flow data may be shared from various sources such as neighbors, water purveyors, water authorities, and/or HOA (homeowners association). The irrigation information may be shared with one another when the information provider consents to share the information. In some embodiments, the information may only be shared between the consented parties.

For example, a user of the irrigation system of the first property or the irrigation controller of the first property finds from the shared information that a neighbor uses less water but the plants on the neighbor's property look good or better, the irrigation controller of the first property may retrieve the neighbor's irrigation schedule and/or the water flow data and then adjust the irrigation schedule for the first property based on the neighbor's irrigation schedule and/or the water flow data.

In some embodiments, the user of the irrigation system of the first property may manually select to retrieve the neighbor's irrigation information and to adjust their irrigation schedule based on the neighbor's irrigation information. In some other embodiments, the irrigation system of the first property may automatically retrieve the neighbor's irrigation information and automatically adjust the irrigation schedule based on the neighbor's irrigation information.

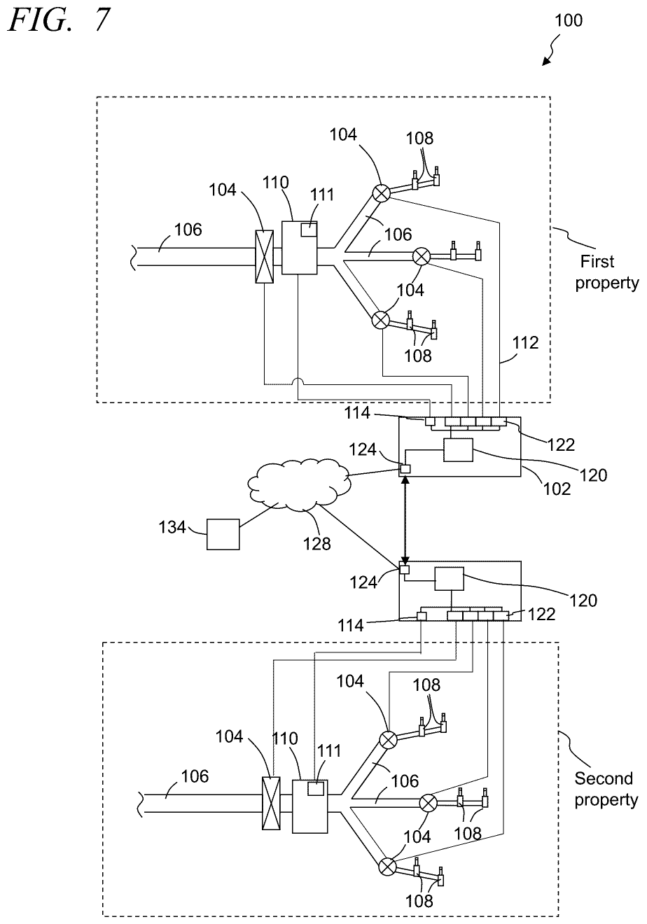

Referring to FIG. 7, in some embodiments, both irrigation systems for the first property and the second property may be equipped with the water flow meter and may compare their water usage to one another based on the shared information. For example, when the irrigation system for the first property detects that the irrigation system for the second property having similar a size to the property and similar type of plants, uses less water but the plants on the property have a better condition (which may be determined, for example, by a user or an image sensor which can determine the condition of the plants), the irrigation system of the first property may adjust its irrigation schedule based on the second property's irrigation schedule and water flow data.

In some embodiments, even sizes, types, and plants of the first and second properties are not similar to each other, the irrigation system may use the shared data by normalizing the irrigation schedule and flow data based on the feature of each property.

In some embodiments, both irrigation systems of FIG. 7 share the same water source and flow sensor 110 provides data relating to flow used by the systems of the first and second properties. In some embodiments, this flow data could be used to adjust irrigation timing of the two systems, so that both systems are not irrigating at the same time in order that pressure and irrigation efficiency can be maintained. In some cases, one system is allowed to irrigate and the other system is delayed until one system has finished irrigating.

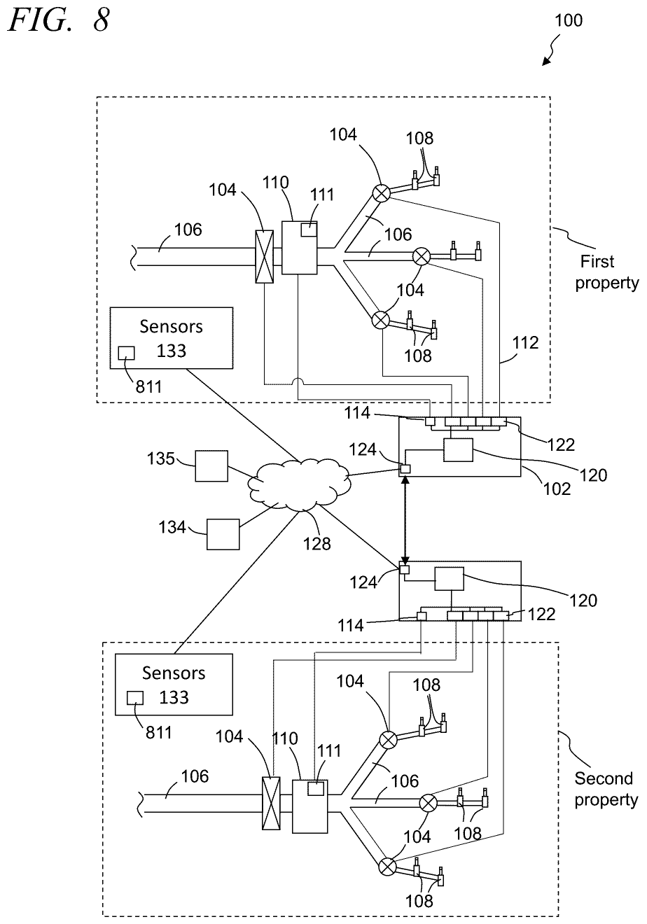

In some embodiments, referring to FIG. 8, the irrigation system for one or more properties may further include one or more sensors 133 in addition to the flow sensor (e.g., the flow meter 110). In some embodiments, the sensors 133 may be communicatively connected to the corresponding irrigation controller 102. In some embodiments, the sensors 133 may be communicatively connected to the communication network 128 independently of the irrigation controller 102. For example, the sensor devices 133 may be directly connected to the communication network 128 and/or the sensor devices 133 may be connected to the communication network 128 via one or more communication hubs 129. In some embodiments, the sensors 131 may still communicate with the irrigation controller 102 via the communication network 128 even when the sensors 131 are communicatively connected to the communication network 129 independently of the irrigation controller 102. The one or more sensors 131 can be substantially any relevant sensor, such as but not limited to, a soil moisture sensor, a rain sensor, a wind sensor, a humidity sensor, an optical sensor (e.g., an image sensor), an acoustic sensor, a sound sensor, a thermal sensor, and other such relevant sensors. In some embodiments, the irrigation controller 102 can receive the sensed information/sensor data from the one or more sensors 133 through direct connections, wireless connections, or other such relevant communication mechanisms.

In some embodiments, the one or more sensors 133 may collect sensor data from the one or more properties and/or related areas of the one or more properties. In this description, the sensor data may generally refer to the sensor data collected using the sensors 133 that exclude the flow meter 110. The related areas may include an area at a same state, a same county, a same city, a same town, or a same zip code area, a neighborhood, an adjacent property, an area belonging to a common community (e.g., a homeowners association), etc. In some embodiments, the one or more sensors 133 may comprise one or more public sensors. In some embodiments, the one or more sensor 133 may comprise one or more private sensors.

In some embodiments, the irrigation systems for multiple properties may share the sensor data and the irrigation controller of each property may use the shared sensor data in adjusting the irrigation schedule. The sensor data may include the flow data measured by the flow meter. In some embodiments, the irrigation systems for the multiples properties may share the sensor data within a neighborhood or a specific geographic area. For example, irrigation systems for multiple properties within the same zip code may share their sensor data.

Because watering or weather or soil condition of one property may affect the adjacent property, the adjacent property's watering or irrigation-related condition may be one of the factors in adjusting or optimizing the irrigation schedule. Based on the shared sensor information, the irrigation controller may anticipate future events that may affect the irrigation of the property.

For example, when a neighbor property has a rain event and a rain sensor of the neighbor property detects the rain event, the rain sensor may send a signal to the irrigation controller connected thereto and the irrigation controller of the neighbor property may send a signal to irrigation controllers in the same geographic area. When the irrigation controllers in the same geographic receive information about the rain event on the neighbor property, the irrigation controllers may suspend or skip the scheduled irrigation cycle or reduce the runtime of irrigation.

And in some embodiments, only one of the first and second properties has a sensor and is configured to share its sensor data with the irrigation controller of the other property.

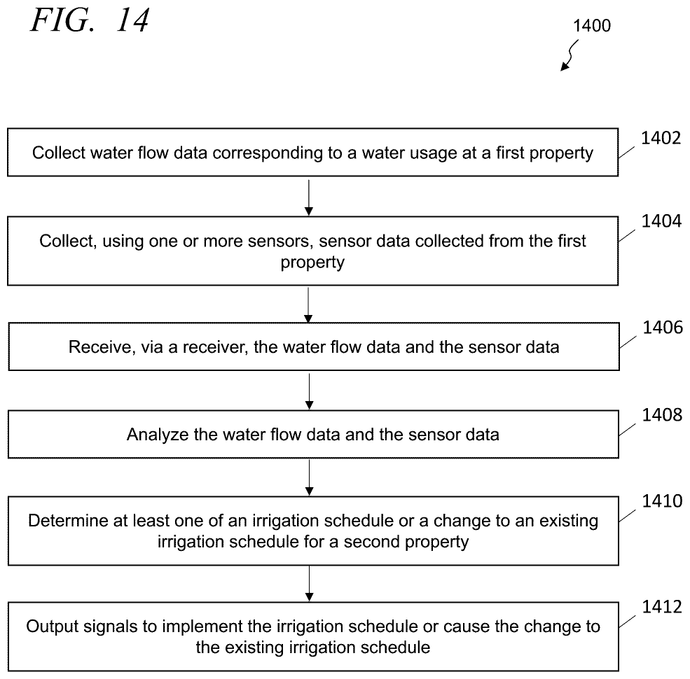

FIGS. 14-19 depict flow diagrams illustrating example methods 1400, 1500, 1600, 1700, 1800, 1900 of controlling irrigation according to some embodiments. The methods 1400, 1500, 1600, 1700, 1800, 1900 may be performed using the system 100 in accordance with the approaches described above. Although the methods 1400, 1500, 1600, 1700, 1800, 1900 are mainly illustrated with the system 100, the methods 1400, 1500, 1600, 1700, 1800, 1900 may also be performed with a system differently configured. Each embodiment described for each method 1400, 1500, 1600, 1700, 1800, 1900 may be applied to, incorporated into, and/or combined with the embodiments for other methods. For example, at least a part or the entirety of an embodiment described for method 1400 may be incorporated into the embodiment described for method 1500.

Referring to FIG. 14, in step 1402, the one or more flow meters 110 may collect water flow data corresponding to a water usage at a first property. In some embodiments, the water flow data collected via the one or more flow meters 110 may correspond to entire water usage including irrigation water usage and non-irrigation water usage at the first property. In some embodiments, the water flow data collected via the one or more flow meters 110 may correspond to the non-irrigation water usage at the first property. In some embodiments, the water flow data collected via the one or more flow meters 110 may correspond to the irrigation water usage at the first property.

In step 1404, the one or more sensors 133 in addition to the one or more flow meters 110 may collect sensor data from the first property. In some embodiments, the one or more sensors 133 may be the private sensors used for the first property. In some embodiments, the sensor data may be collected from an irrigation area of the first property. The sensor data may include, but is not limited to, temperature, humidity, wind speed, solar radiation, rainfall, imagery data, and other relevant sensor data collected from the first property. In some embodiments, the one or more sensors 133 may comprise an image sensor configured to collect imagery data from its detection area (e.g., an irrigation area of the first property, or an area adjacent/related to the irrigation area of the first property), and the imagery data may represent one or more conditions/status of the detection area.

In step 1406, a receiver 1320 (or a transceiver) may receive the water flow data and the sensor data. In some embodiments, the receiver 1320 may be a transceiver 1211 of the data analysis unit 121 connected to the communication network 128. In some embodiments, the transceiver 1211 of the data analysis unit 121 may receive the water flow data and the sensor data via the communication network 128. The communication network 128 transmitting the water flow data and the sensor data to the data analysis unit 121 may be the internet network. In some embodiments, the server 135 may comprise the data analysis unit 121 and the transceiver 1211 receiving the water flow data and the sensor data in step 1406 may be a transceiver of the server 135. In some embodiments, the server 135 that receives the water flow data and the sensor data may be a remote server communicatively connected to the communication network 128. In some embodiments, the server 135 that receives the water flow data and the sensor data may be a remote server communicatively connected to the internet network.

In some embodiments, the flow meter 110 may transmit the water flow data via a transmitter 111 (or a transceiver) of the flow meter 110. In some embodiments, the transmitter 111 of the flow meter 110 may be a wireless transmitter such that the flow meter 110 may transmit the water flow data wirelessly. In some embodiments, the irrigation controller 102 of the first property may receive, via the transceiver 124 of the irrigation controller 102, the water flow data and then transmit, via the transceivers 124, the received water flow data to the receiver 1211 of the data analysis unit 121. In some other embodiments, the water flow data is transmitted from the flow meter 110 to the one or more data analysis unit 121 via the communication network 128 and/or the communication hub 129 but independently of the irrigation controller 102 of the first property.

In some embodiments, the one or more sensors 133 may transmit the sensor data via a transmitter 811 (or a transceiver) of the one or more sensors 133. In some embodiments, the transmitter 811 may be a wireless transmitter such that the one or more sensors 133 may transmit the sensor data wirelessly. In some embodiments, the irrigation controller 102 of the first property may receive, via the transceiver 124 of the irrigation controller 102, the sensor data and then transmit, via the transceivers 124, the received sensor data to the receiver 1211 of the one or more data analysis unit 121. In some embodiments, the sensor data is transmitted from the one or more sensors 133 to the data analysis unit 121 via the communication network 128 and/or the communication hub 129 but independently of the irrigation controller 102 of the first property.

In some embodiments, the communication hub 129 may be a communication hub at the first property (e.g., a router at the first property). In some embodiments, the communication hub 129 may be a communication hub at other's property (e.g., a router at a third party's property) or a communication hub at a public property (e.g., a mobile phone activating its mobile Hotspot and/or Bluetooth function at a street near the first property). The communication hub 129 that receives the water flow data and the sensor data may transmit the received water flow data and the sensor data to another communication hub 129 or to the one or more data analysis unit 121. In some embodiments, the communication hub receiving and transmitting the water flow data may be the same as the communication hub receiving and transmitting the sensor data. In some embodiments, the communication hub receiving and transmitting the water flow data may be different from the communication hub receiving and transmitting the sensor data. For example, the water flow data transmitted from the flow meter 110 to the data analysis unit 121 may be via a first communication hub (e.g., the flow meter 110 may transmit the water flow data to the first communication hub, and the first communication hub may transmit the received water flow data to the data analysis unit 121), and the sensor data transmitted from the one or more sensors 133 to the data analysis unit 121 may be via a second communication hub (e.g., the one or more sensors 133 may transmit the sensor data to the second communication hub, and the second communication hub may transmit the received sensor data to the data analysis unit 121).

In some embodiments, the water flow data and the sensor data may be transmitted from the flow meter 110 and the one or more sensors 133 to the transceiver 1121 of the data analysis unit 121 via two or more communication hubs 129 connected to one another. In some embodiments, when there are more than one communication hubs 129 to which the transmitter (or transceiver) 111 of the flow meter 110 and/or transmitter (or transceiver) 811 of the sensors 133 may access, the flow meter 110 and/or the sensors 133 may transmit the water flow data and/or the sensor data to the communication hub 129 that may establish or provide the strongest and/or fastest communication connection between the transmitter 111 of the flow meter 110 and/or the transmitter 811 of the sensors 133. In some embodiments, the communication hub 129 does not necessarily have to be the nearest communication hub or a communication hub at the first property. By using one or more of non-designated (or open) communication hubs 129 that may form a mesh network, the flow meter 110 and the sensors 133 may effectively transmit the data and/or reduce data transmission delay due to a network connection issue. In some embodiments, at least one of the first communication hub and the second communication hub is at the first property. In some embodiments, at least one of the first communication hub and the second communication hub is not at the first property.

In some embodiments, the transceiver 1211 of the data analysis unit 121 may further receive or retrieve the past and/or the current irrigation schedule. The past and/or the current irrigation schedule may be transmitted from, but not limited to, at least one of the irrigation control unit 101, the database 139, the server 135, the supervisory controller 137, the irrigation controller, and/or the user computing device 132 or be retrieved from the database 139.

In some embodiments, the method 1400 may further comprise a step of prompting a user to enter a user input to collect the sensor data using the one or more sensors. Additionally or alternatively, in some embodiments, the one or more sensors 133 comprise an image sensor of a mobile electronic device and, and the method 1400 may further comprise a step of prompting a user to take an image (e.g., a photo) or record a video using the mobile electronic device to collect the sensor data. In some embodiments, the system 100 (e.g., the data analysis unit 121) may output signals to prompt the user to enter the user input to cause the sensors 133 to collect the sensor data and/or prompt the user to collect the sensor data using the mobile electronic device before performing step 1404, when the data analysis unit 121 determines that the received sensor data is out of data and/or that additional sensor data is necessary to performing analyzing the water flow data and/or the sensor data in next step 1408.

In step 1408, the data analysis unit 121 may analyze the water flow data and/or the sensor data. For example, in step 1408, the data analysis unit 121 may analyze the water flow data to identify the water usage patterns, irrigation water usage and/or non-irrigation water usage, property water demand over time, property water demand over day of the week, property water demand over months, property water demand over the seasons, and so on. In some embodiments, in analyzing the data, the data analysis unit 121 may associate the water flow data, analyzed water flow data, and/or the past/current irrigation schedule with the sensor data. For example, the data analysis unit 121 may associate the irrigation water usage pattern with the humidity data.

In step 1410, the data analysis unit 121 may determine, based on the analyzed water flow data and the sensor data, at least one of an irrigation schedule to be executed at a second property (e.g., a new irrigation schedule to be executed at the second property)_and a change to an existing/current irrigation schedule to be executed at the second property. In this step, using the analyzed data collected from the first property, the data analysis unit 121 may determine at least one of the new irrigation schedule to be executed at the second property and the change to the existing/current irrigation schedule currently being executed at the second property.

In some embodiments, the second property does not have a flow meter corresponding to the flow meter 110 at the first property that is configured to collect the water flow data corresponding to the water usage at the first property and transmit the collected water flow data to the one or more data analysis unit 121 (e.g., the server 135 comprising the data analysis unit 121). In some embodiments, the second property does not have a flow meter configured to collect water flow data and transmit the collected water flow data to the one or more data analysis unit 121 (e.g., the server 135 comprising the data analysis unit 121). In some embodiments, the second property does not have sensors corresponding to the one or more sensors collecting the sensor data from the first property. In some embodiments, the second property does not have sensors configured to collect sensor data from the second property and transmit the collected sensor data to the one or more data analysis unit 121 (e.g., the server 135 comprising the data analysis unit 121). By utilizing the water flow data and the sensor data collected from another property, the irrigation system 100 may determine an irrigation schedule and/or a change to the irrigation for a property without a flow meter and/or sensor more effectively.

In step 1412, the data analysis unit 121 may output signals to implement and/or to cause implementation of the irrigation schedule determined in step 1410 at the second property or cause the change determined in step 1410 to the existing irrigation schedule executed at the second property. In some embodiments, the irrigation control unit 101 may execute the irrigation schedule or the change to the existing irrigation schedule to cause irrigation at the second property. In some embodiments, the data analysis unit 121 may output signals to cause the irrigation control unit 101 to execute the irrigation schedule or the change to the existing irrigation schedule to cause irrigation at the second property.

In some embodiments, the first property is owned, used, and/or irrigated by a first entity and the second property is owned, used, and/or irrigation by a second entity, and the method 1400 may further comprise obtaining, from the first entity, a consent to share the water flow data and the sensor data. In some embodiments, the method 1400 may further comprise obtaining, from the first entity, a consent for the irrigation system (e.g., the data analysis unit 121) to analyze and/or use the shared water flow data and the sensor data to determine irrigation schedules or changes to the existing irrigation schedule for other's property (e.g., the second property). In some embodiments, the method 1400 may further comprise obtaining a consent from the second entity that the irrigation system 100 can automatically implement the irrigation schedule or the changes to the existing irrigation schedule for the second property determined based on other's flow data and sensor data (e.g., the flow data and the sensor data collected from the first property).

In some embodiments, the first property may be near to or adjacent to the second property. In some embodiments, the first property and the second property may be in a common geographic area (e.g., a common state, county, city, town, neighborhood, zip code, etc.). In some embodiments, the first and the second property may have similar landscape characteristics. The landscape characteristics may include, but are not limited to, composition/components of the landscape, usage of the landscape, types of plants on the landscape, soil type of the landscape, depth of the soil of the landscape, topography of the land scape (e.g., the contours, slopes, elevations, and overall shape of the terrain), water features (e.g., existence of rivers, lakes, streams, oceans, waterfalls, and wetlands), climate (e.g., weather conditions such as temperature, precipitation, humidity, and seasonal changes influence the types of vegetation in the area), geological features (e.g., the underlying geological structures like rock formations and minerals), and/or light conditions (e.g., the quality and quantity of light, including sunlight and artificial light).

It is noted that while the method is discussed with reference to a first property and a second property, it is understood that the sensor and/or flow data provided at one location (such as a first property) can be processed by a data analysis module and shared with more than devices at a second property. That is, the data and/or decisions made based on the data (such as an irrigation schedule or adjustment to a schedule) may be shared to multiple devices at multiple properties. In some cases, the data analysis module or other server is programmed to know to which devices at what properties are to receive shared data or decisions/determinations. For example, data and/or determinations may be shared to all consenting irrigation controllers in the a given area/region or that have similar landscape/irrigation characteristics.

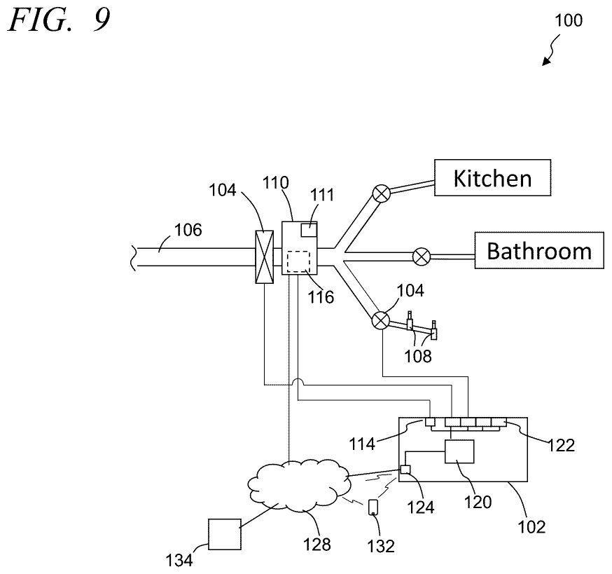

In some embodiments, the irrigation control unit 101 may adjust or optimize the irrigation schedule based on the total water usage and demand of an entirety of a property or a group of multiple properties. The property may be, but not limited to, a residential, commercial, industrial, educational, or recreational property and the property may include a structure having an indoor area intended for occupation by at least one person with one or more water consumption components and an irrigation area with the water emitters 108 for irrigation. FIG. 9 is a simplified diagram of example water distribution for a residential unit. A residential unit typically includes water-consuming devices or utilities other than water emitters 108 for irrigation. For example, the residential unit may include kitchen utilities such as a sink, dishwashers, water purifiers, etc. The residential unit may also include bathroom utilities such as a toilet, a washstand, a bathtub, a shower, etc. The use of these water-consuming devices or utilities may affect the entire water usage.

In some cases, when the water demand from the common water conduit is high, the pressure of water in the water conduit may be reduced, which may cause a negative effect on irrigation efficiency and may cause non-enough watering. To avoid these inconveniences, the irrigation control unit 101 and/or the data analysis unit 121 may adjust the irrigation schedule based on the amount of water consumed at the whole property. In some embodiments, the amount of water consumption at the whole property (e.g., whole home) may be determined based on the water flow data measured by the flow meter. The data analysis module 116 may determine which utilities or device is consuming the water based on the water usage pattern from the water flow data and/or real-time water flow measurement. The irrigation control unit 101 and/or the data analysis module 116 may shift the irrigation schedule if the scheduled irrigation often overlaps with other water usage at the property (e.g., home).

In some embodiments, the irrigation controller may adjust the irrigation schedule or shift a scheduled irrigation to minimize or avoid simultaneous water usage without a violation of a predetermined rule. The predetermined rule may be set by a user or a manufacturer of the irrigation system. The predetermined rule may be related to the irrigation condition. For example, the rule may be set to allow the irrigation controller to shift the scheduled irrigation within certain times of the day or to prevent the irrigation controller from shifting the scheduled irrigation to the nighttime.

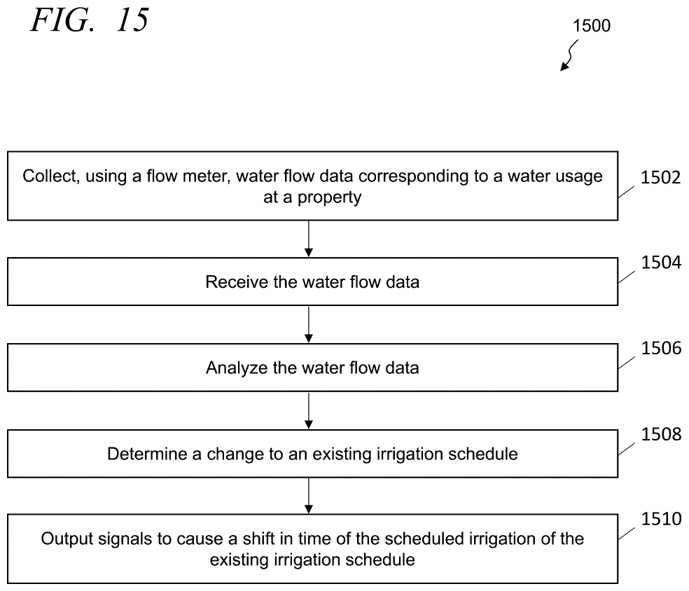

Referring to FIG. 15, in step 1502, the one or more flow meters 110 may collect water flow data corresponding to a water usage at a property. In some embodiments, the water flow data collected via the one or more flow meters 110 may correspond to water usage at the property including both irrigation water usage and non-irrigation water usage at the property. In some embodiments, the water flow data collected via the one or more flow meters 110 may correspond to the non-irrigation water usage at the property.

In step 1504, the data analysis unit 121 (having a data analysis module 116) may receive the water flow data. In some embodiments. The data analysis unit 121 may receive the water flow data via the transceiver 1211. In some embodiments, the data analysis unit 121 may further receive the past and/or the current irrigation schedule for the property.

In step 1506, the data analysis unit 121 may analyze the water flow data. For example, in step 1506, the data analysis unit 121 may analyze the water flow data to identify a property water usage pattern over a period of time, an irrigation water usage pattern over the period of time, a non-irrigation water usage pattern over the period of time, property water demand over a period of time, one or more water usage activities, and so on. In some embodiments, the analyzing of the flow data is provided over time to learn patterns in property water uses, non-irrigation water uses, and/or irrigation water uses. The period of time comprises at least one of a daily period or weekly period. The water usage activities may include at least one of irrigation water usage activities and/or non-irrigation water usage activities. To identify the non-irrigation water usage patterns or the one or more non-irrigation water usage activities, in some embodiments, the data analysis unit 121 may consider the past and/or the current irrigation schedule for the property. When the water flow data that the data analysis unit 121 receives corresponds to the whole-property water usage, the data analysis unit 121 may consider the past and/or current irrigation schedule for the property to identify the non-irrigation water usage.

In some embodiments, the data analysis unit 121 may analyze a water signature of the water flow data to identify one or more water usage activities. The water signature may be related to a distinct pattern or profile of water flow characteristics, such that the data analysis unit 121 may identify the water usage activities based on the water signature.

In some embodiments, the water usage activities may correspond to activities of the water consumption components. The water consumption components may include, but are not limited to, at least one of a bathtub, a shower booth, a basin, a toilet, a sink, a dishwasher, a washing machine, or the one or more water emitters 108.

In some embodiments, the method 1500 may further comprises, before step 1506, receiving user input information regarding one or more water consumption components connected with a water supply to the property and the data analysis unit 121 may identify, in step 1506, the water usage activities further based on the user input information regarding the one or more water consumption components.

In some embodiments, the analyzing of the flow data is provided using an algorithm and/or the trained machine learning model 1210. Data is analyzed in a real-world system, not a theoretical system.

In step 1508, the data analysis unit 121 may determine, based on the analyzed water flow data, a change to an existing irrigation schedule. The change to the existing irrigation schedule determined in step 1508 may be a shifting in time of a scheduled irrigation of the existing irrigation schedule. In some embodiments, the change may shift the time of the scheduled irrigation of the existing irrigation schedule within a period of time (e.g., 24 hours, day, week, month, or customer defined period of time, etc.). In some embodiments, determining the change is further based on a non-irrigation water use pattern over a period of time.

In some embodiments, wherein the change is determined further based on a priority of the one or more non-irrigation water usage activities. The priority of the one or more non-irrigation water usage activities may be defined by a user associated with the property and/or an authorized party. In some embodiments, the method 1500 may further include, before step 1508, receiving user input regarding the priority of the one or more non-irrigation water usage activities via a user interface.

In some embodiments, the property includes a structure having an indoor area, and the non-irrigation water usage comprises indoor water usage that has a higher priority than irrigation water usage or other outdoor non-irrigation water use. For example, the property is a residential property having a residence home, and the non-irrigation water usage comprises in-home water usage that has a higher priority than irrigation water usage. In another example, the property is a commercial property having a commercial building, and the non-irrigation water usage comprises in-building water usage that has a higher priority than irrigation water usage.

In step 1510, the data analysis unit 121 may output signals to cause a shift in the time of the scheduled irrigation of the existing irrigation schedule. In some embodiments, outputting the signals to cause the shift in time of the scheduled irrigation of the existing irrigation schedule does not change a watering amount of the scheduled irrigation and/or a watering duration of the scheduled irrigation. In some embodiments, when the property includes a plurality of irrigation zones, outputting the signals may cause the shift in the time of the scheduled irrigation of the existing irrigation schedule for a subset of the plurality of irrigation zones. In some embodiments, outputting the signals may cause the shift in the time of the scheduled irrigation of the existing irrigation schedule for the entirety of the plurality of irrigation zones.

In some embodiments, outputting the signals may cause the shift in time of the scheduled irrigation to one or more time slots where there is no or minimal non-irrigation water usage. For example, when the property is a residential property having a residence home, outputting the signals may cause the shift in time of the scheduled irrigation to one or more time slots where no or minimal in-home water usage.

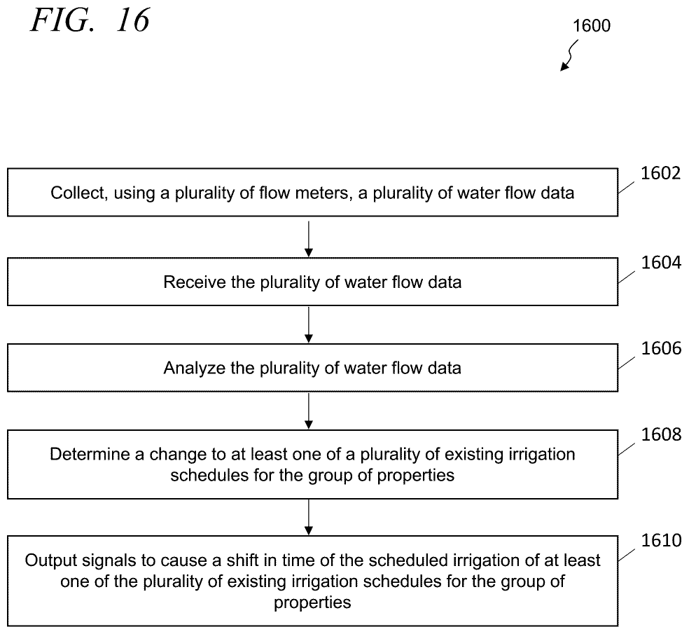

FIG. 16 depicts a flow diagram illustrating an example method 1600 of controlling irrigation for a group of properties according to some embodiments. In some embodiments, the group of properties may comprise a plurality of properties to which water is supplied by a common water authority, a plurality of properties using a common parent conduit, a plurality of properties using a common master conduit, a plurality of properties in a common geographic area, and/or a plurality of properties that belongs to a common community (e.g., a homeowners association).

In step 1602, a plurality of flow meters 110 may collect a plurality of water flow data, each of which may correspond to a water usage at each property of a group of properties. In some embodiments, each water flow data may correspond to the entire water usage including irrigation water usage and non-irrigation water usage at each property of the group of property. In some embodiments, each water flow data may correspond to the non-irrigation water usage at each property of the group of properties.

In step 1604, the data analysis unit 121 may receive the plurality of water flow data. In some embodiments, the data analysis unit 121 may further receive or retrieve the past and/or the current irrigation schedules executed at one or more of the group of properties.

In step 1606, the data analysis unit 121 may analyze the plurality of water flow data. For example, in step 1606, the data analysis unit 121 may analyze the plurality of water flow data to identify water usage patterns over a period of time for the entirety of and/or each of the group of properties, irrigation water usage patterns over the period of time for the entirety of and/or each of the group of properties, non-irrigation water usage patterns over the period of time for the entirety of and/or each of the group of properties, water demand over a period of time for the entirety of and/or each of the group of properties, one or more water usage activities for the entirety of and/or each of the group of properties, and so on. The period of time comprises at least one of a daily period or weekly period. In some embodiments, the data analysis unit 121 may determine an anticipated water usage amount and/or an anticipated water demand for the period of time for the entirety of and/or each of the group of properties. The anticipated water usage and/or the anticipated water demand may be determined based on the water usage patterns. In some embodiments, the analyzing of the plurality of flow data is provided over time to learn patterns of water uses.

In some embodiments, the method 1600 may further comprise receiving user input information regarding one or more water consumption components connected with a water supply to at least one of the group of properties before step 1606 and the data analysis unit 121 may identify the water usage activities further based on the user input information regarding the one or more water consumption components.

In step 1608, the data analysis unit 121 may determine, based on the analyzed plurality of water flow data, a change to at least one of a plurality of existing irrigation schedules executed at least one of the group of properties. In some embodiments, the change determined in step 1608 may comprise a shifting in time of a scheduled irrigation of at least one of the plurality of existing irrigation schedules executed at least one of the group of properties within a period of time. In some embodiments, the change may comprise reducing in watering amount and/or watering duration of a scheduled irrigation of at least one of the plurality of existing irrigation schedules executed at the group of properties.

In step 1610, the data analysis unit 121 may output signals to cause the determined change to at least one of the plurality of existing irrigation schedules for the group of properties. In some embodiments, outputting the signals comprises outputting signals to cause a shift in the time of a scheduled irrigation of at least one of the plurality of existing irrigation schedules executed at one or more properties of the group of properties. In some embodiments, outputting the signals comprises outputting signals to reduce in watering amount and/or watering duration of a scheduled irrigation of at least one of the plurality of existing irrigation schedules executed at one or more properties of the group of properties.

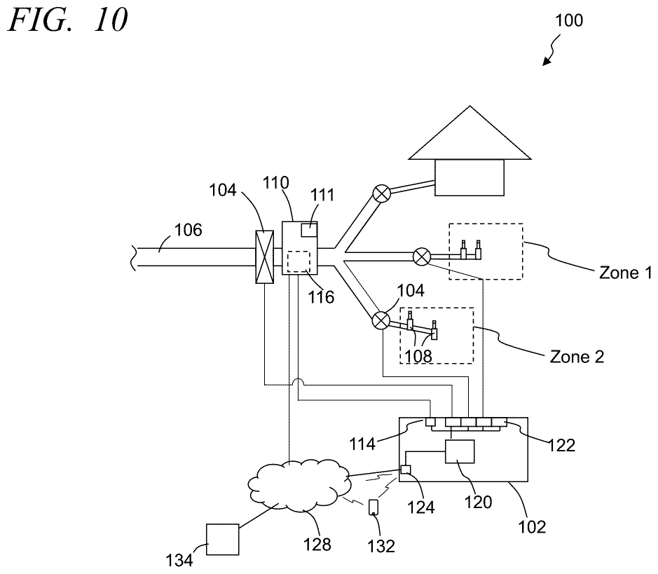

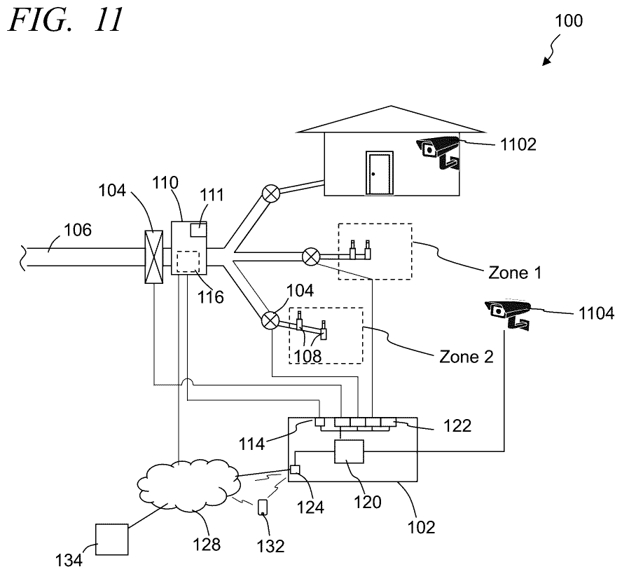

In some embodiments, the irrigation system may use the water flow data from a flow meter to decrease system total irrigation duration by increasing the number of irrigation zones or irrigation stations to be watered at the same time. As shown in FIG. 10, the irrigation system may comprise more than one zone (station) to be watered. The irrigation schedule may typically be set to water one zone at a time in order to ensure adequate water pressure in the event there are other resources using trying to simultaneously use water.

In some embodiments, when the data analysis module 116 determines that no water is being consumed or only small amount of water, which is small enough to allow watering a plurality of irrigation stations at a same time, is being consumed by the home during a certain time period based on the pattern of water flow data and/or real-time water flow measurement, the data analysis unit 121 and/or the irrigation control unit 101 may adjust the irrigation schedule to allow more than one zone to be watered at a time by increasing the number of zones to be watered at a time.

In some embodiments, if the irrigation schedule (e.g., user-defined irrigation schedule or adjusted irrigation schedule based on the flow data) has been set to water more than one zone at a time, when the data analysis unit 121 detects one or more water usage other than the irrigation based on the patterns of water flow and/or real-time water flow measurement, which may affect water pressure supplied by the conduit connected to the water emitters 108 at the zones scheduled to be watered, the irrigation control unit 101 may reduce the number of zones watered at a time by shifting the scheduled irrigation for one or more zones to other time. When the data analysis unit 121 and/or the irrigation control unit 101 detects water usage other than the irrigation, the irrigation control unit 101 may immediately output signals to reduce the number of zones (stations) currently being watered.

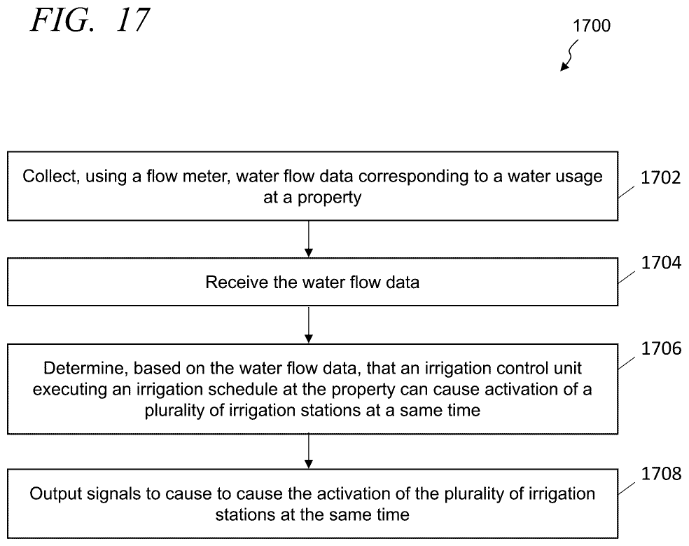

Referring to FIG. 17, in step 1702, the one or more flow meters 110 may collect water flow data corresponding to a water usage at the property. In some embodiments, the water flow data collected via the one or more flow meters 110 may correspond to water usage at the property including both irrigation water usage and non-irrigation water usage at the property. Depending on the location of the flow meter, the water usage may be the entire water usage at the property. In some embodiments, the water flow data collected via the one or more flow meters 110 may correspond to the non-irrigation water usage at the property.

In step 1704, the data analysis unit 121 may receive the water flow data. In some embodiments, the data analysis unit 121 may further receive or retrieve the past and/or the current irrigation schedule for the property.

In step 1706, the data analysis unit 121 may determine, based on the water flow data, whether a plurality of irrigation stations can be activated at the same time. For example, the data analysis unit 121 may determine, based on the water flow data, whether the irrigation control unit 101 (e.g., the irrigation controller 102) executing an irrigation schedule at the property can cause, based on the water flow data, activation of a plurality of irrigation stations at the same time. For example, when there is no water flow for non-irrigation usage based on the patterns of water flow and/or real-time water flow measurement, the data analysis unit 121 may determine that the irrigation control unit 101 can activate the plurality of irrigation stations at the same time.

In some embodiments, the data analysis unit 121 may analyze the water flow data and determine, based on at least one of identified information from the analysis of the water flow data, whether a plurality of irrigation stations can be activated at the same time.

In some embodiments, with respect to method 1700, the irrigation schedule may not be programmed for the activation of the plurality of irrigation stations at the same time. The existing irrigation schedule may be programmed to only activate one of the plurality of irrigation stations at a time.

In some embodiments, the data analysis unit 121 may analyze the water flow data to identify a non-irrigation water usage (e.g., when the water flow data is corresponding to a water usage including both irrigation and non-irrigation usage at the property), a property water usage pattern over a period of time, an irrigation water usage pattern over the period of time, a non-irrigation water usage pattern over the period of time, water demand over a period of time for the entire property, water demand over a period of time for non-irrigation water use at the property, one or more water usage activities, and so on.

In step 1708, the data analysis unit 121 may output signals to cause the activation of the plurality of irrigation stations at the same time. In some embodiments, the data analysis unit 121 may be a different unit from the irrigation control unit 101. In this case, the data analysis unit 121 may output the signals to cause the irrigation control unit 101 to cause the activation of the plurality of irrigation stations at the same time. In some embodiments, the irrigation control unit 101 may be the irrigation controller 102.

In some embodiments, outputting the signals may cause the plurality of irrigation stations to be activated during a period unscheduled for watering for an entirety of the plurality of irrigation stations according to an existing irrigation schedule. For example, if the property includes three irrigation stations, outputting the signals may cause two or three irrigation stations to be activated during a period when all three irrigation stations are unscheduled for watering according to the existing irrigation schedule.

In some embodiments, outputting the signals may cause the plurality of irrigation stations to be activated during a period when watering is not scheduled for a subset of the plurality of the irrigation stations while watering is scheduled for at least one other irrigation stations of the plurality of irrigation stations according to an existing irrigation schedule. For example, if the property includes three irrigation stations, outputting the signals may cause two irrigation stations to be activated during a period when watering is not scheduled for a first and a second irrigation stations, but watering is scheduled for a third irrigation station according to the existing irrigation schedule. In this example, at least one of the first or second irrigation stations may be activated in addition to the third irrigation station during the period.

In some embodiments, the water flow data measured by the flow meter and/or the water flow data analyzed by the data analysis module may be shared with or transmitted to a local water authority. The local water authority may track the irrigation water usage of each property (e.g., household) by analyzing the transmitted water flow data or receiving the analyzed water flow data indicating water usage for irrigation. The local water authority may also track the irrigation water usage of a specific geographic region or area, a neighborhood, and/or an HOA based on the transmitted water flow data. In some embodiments, the local water authority may request to change or recommend changing one or more irrigation schedules executed by the irrigation controller based on the tracked irrigation water usage. In some embodiments, the local water authority may request to change or recommend changing the irrigation schedules for one or more properties in a specific geographic region or area, a neighborhood, and/or an HOA.

Additionally or alternatively, the water authority may generate an irrigation schedule for an individual irrigation controller, a household, a geographical region, or an HOA based on the irrigation water usage tracked from the water flow data and provide the generated irrigation schedule to corresponding users. The water schedule provided by the water authority use less water than a homeowner might generally intend to use. To encourage adoption, the water authority may provide discounts or credits on the property user's water bill when the property user follows the irrigation schedule the water authority provides.

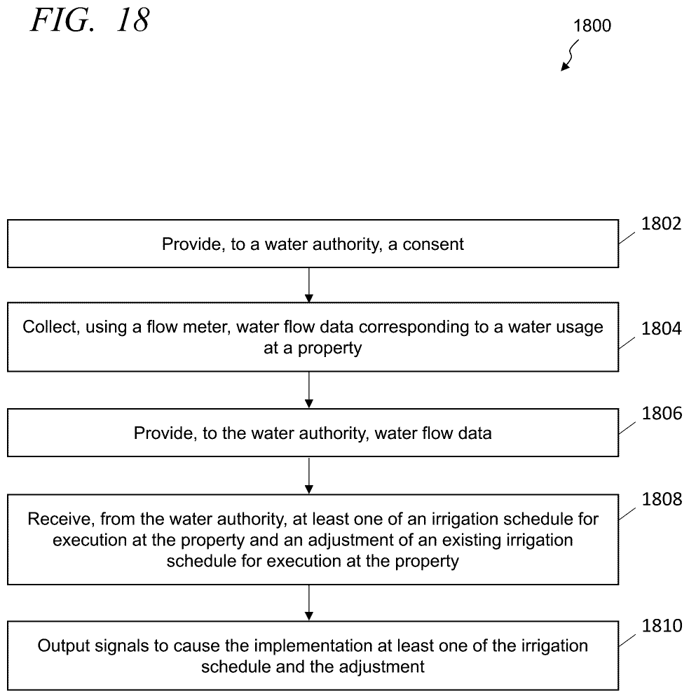

Referring FIG. 18, in step 1802, the irrigation system 100 may provide, to a water authority, a consent from a user that an irrigation schedule to be executed at the property will be provided by the water authority. In some embodiments, the irrigation system 100 may also provide, to a water authority, a consent from the user that the user consents that the irrigation schedule provided by the water authority will be executed at the property. In some embodiments, the consent that an irrigation schedule to be executed at the property will be provided by the water authority may be provided to the water authority in exchange for a reduction of an obligation to the water authority. Additionally or alternatively, providing the consent indicating that the user consents that the irrigation schedule provided by the water authority will be, automatically or in response to the user's confirmation, executed at the property may be in exchange for a reduction of the obligation to the water authority. For example, when the consent(s) is provided to the water authority, the water authority may provide reduction of the obligation to the water authority to a corresponding user.

The reduction of the obligation to the water authority may comprise one or more of a billing reduction, a rebate, a credit, billing in a different tier, and billing for a different volume of water use.

In some embodiments, providing the consent may be in responsive to an offer provided by the water authority. The offer may include an offer to provide reduction of the obligation to the water authority in response to provision of the consent from a user that an irrigation schedule to be executed at the property will be provided by the water authority and/or the consent, from the user, that the irrigation schedule provided by the water authority will be executed at the property.

It is understood that the consent can be provided by a user, such as an owner of a given property. In some embodiments, the consent could come from an authorized agent for the user or property. An authorized agent could be an entity other than a property owner, such as a renter, relative, landscape professional, homeowner association agent, etc.

To obtain the consent from the user, the method 1800 may further comprises receiving, via a user interface, a user input indicating that the user consents that an irrigation schedule to be executed at the property will be provided by the water authority and/or the user consents that the irrigation schedule provided by the water authority will be executed at the property.

In step 1804, the one or more flow meters 110 may collect water flow data corresponding to a water usage at the property. In some embodiments, the water flow data collected via the one or more flow meters 110 may correspond to water usage at the property including irrigation water usage and non-irrigation water usage at the property. In some embodiments, the water flow data collected via the one or more flow meters 110 may correspond to the non-irrigation water usage at the property.

In step 1806, the water flow data collected from the one or more flow meter 110 may be provided to a water authority. In some embodiments, the water flow data may be provided to the water authority without analysis by the irrigation system (e.g., the data analysis unit 121 of the irrigation system 100). In some embodiments, the data analysis unit 121 may receive the water flow data from the flow meter 110 and analyze the water flow data to identify, from the water flow data, necessary information to be provided to the water authority. In some embodiments, the information identified by the analysis of the water flow data may be provided to the water authority. In some embodiments, the analyzed water flow data provided to the water authority may include, but not limited to, a whole property water usage pattern over a period of time, an irrigation water usage pattern over the period of time, a non-irrigation water usage pattern over the period of time, entire property water demand over a period of time, one or more water usage activities, and so on. In some embodiments, the past and/or existing irrigation schedules may further be provided to the water authority.

In step 1808, the irrigation system (e.g., the irrigation control unit 101 or the data analysis unit 121) may receive, from the water authority, at least one of an irrigation schedule for execution at the property or an adjustment of an existing irrigation schedule for execution at the property.

In some embodiments, the irrigation schedule for execution at the property or the adjustment of the existing irrigation schedule for execution at the property received from the water authority may be determined by the water authority. In some embodiments, the irrigation schedule for execution at the property or the adjustment of the existing irrigation schedule for execution at the property received from the water authority may be determined based on the water flow data and/or the analyzed water flow data provided to the water authority (e.g., the water flow data obtained from the flow meter and corresponding to the water usage at the property). In some embodiments, the irrigation schedule for execution at the property or the adjustment of the existing irrigation schedule for execution at the property received from the water authority may be determined based on the water flow data obtained from the flow meter and corresponding to the water usage at the property and additional water flow data corresponding to water usage at one or more additional properties. In some embodiment, the one or more additional properties may be one or more properties that may affect the water supply capacity associated with the property at which at least one of the irrigation schedule and the adjustment of the existing irrigation schedule is executed. In some embodiments, the water to the property at which at least one of the irrigation schedule and the adjustment of the existing irrigation schedule is executed and the one or more additional properties may be supplied by the same water authority. In some embodiments, the water to the property at which at least one of the irrigation schedule and the adjustment of the existing irrigation schedule is executed and the one or more additional properties may be supplied via a common parent conduit.

In some embodiments, the water authority may further receive water flow data and/or analyzed water flow data corresponding to other properties that are under its authority or belong to a common geographic area or a common community and may determine the irrigation schedule for execution at the property or the adjustment of the existing irrigation schedule for execution at the property based on the (analyzed) water flow data corresponding to the property and the (analyzed) water flow data corresponding to other properties.

In some embodiments, the adjustment received from the water authority may comprise a shifting in time of a scheduled irrigation of the existing irrigation schedule. In some embodiments, the adjustment may comprise reducing in watering amount and/or in watering duration of a scheduled irrigation of the existing irrigation schedule.

In step 1810, the irrigation control unit 101 may output signals to cause the implementation of at least one of the irrigation schedule and the adjustment. In some embodiments, outputting the signals may cause a shift in time of a scheduled irrigation of the existing irrigation schedule. In some embodiments, outputting the signals may cause reduction in watering amount and/or watering duration of a scheduled irrigation of the existing irrigation schedule. In some embodiment, outputting the signals may a shift in time of a scheduled irrigation of the existing irrigation schedule to one or more time slots where anticipated water usage from the water authority is lower than a threshold capacity value. The threshold capacity value may be determined by the water authority, and may be different at different times of the day or season, for example. In some embodiments, the threshold capacity value may be a certain percentage of the water authority's water supply capacity. For example, the threshold capacity value may be 50% of the water authority's water supply capacity. In some embodiments, outputting the signals may cause a reduction in at least one of a watering amount and a watering duration of a scheduled irrigation of the existing irrigation schedule.

In some embodiments, the water authority may further determine an irrigation schedule for execution at the other properties and/or an adjustment of the existing irrigation schedule for executions at the other properties. In some embodiments, the irrigation schedule and/or the adjustment to the existing irrigation schedule for the property determined by the water authority may have a common period of time for irrigation and/or a common period of time not allowing irrigation. For example, both the irrigation schedule for execution at the other properties determined by the water authority and the irrigation schedules for execution at the other properties determined by the water authority may have a first period of time where no irrigation is allocated. In another example, both the adjustment to the existing irrigation schedule for the property determined by the water authority and the adjustment to the existing irrigation schedules for the other properties determined by the water authority may include a shift in time of an irrigation scheduled during a second period of time to a third period of time. In some embodiments, the first period of time and the second period of time may comprise one or more time slots where anticipated water usage from the water authority is higher than a threshold capacity value. In some embodiments, the third period of time may comprise one or more time slots where anticipated water usage from the water authority is higher than a threshold capacity value. In some embodiments, the threshold capacity value for each of the first, second and third period of time may be the same or different from one another.

In some embodiments, outputting the signals to cause the implementation of at least one of the irrigation schedule and the adjustment is automatically performed in response to reception of the at least one of the irrigation schedule for execution at the property and the adjustment of the existing irrigation schedule for execution at the property.

In some embodiments, the irrigation system may adjust an irrigation schedule for stations programmed to irrigate with cycle and soak using the water flow data. Cycle and soak refers to an irrigation method where water is applied to the property in multiple, short cycles cycling between watering (cycle on) and not watering (to allow water to soak into the soil rather than run off). To maximize the advantage of the cycle and soak irrigation, it is important to apply amounts of water considering the infiltration rate of soil in each specific area to be watered. If the applied water rate during the cycle phase is less than the infiltration rate of the soil, then additional water could have been applied without runoff and additional cycle phase may be needed to apply the desired amount of water. By contrast, if the applied water rate is greater than the infiltration rate of the soil, it may cause runoff and water waste.

Although the irrigation schedule may be set to apply water to be consistent with the infiltration rate of the soil, sometimes, the amount of water actually applied may slightly differ from the scheduled amount due to various reasons such as but not limited to damage or wear of valve or water emitting devices, low pressure of water in the conduit, uncharged conduit, etc.

In some embodiments, the irrigation system may calculate the amount of water applied from the water flow data and if there is a discrepancy between the rate of applying water and the infiltration rate of the soil, the irrigation controller may adjust the irrigation schedule and/or the cycle and soak periods to offset the discrepancy.

In some embodiments, the irrigation system may adjust the irrigation schedule by using the information/data provided by a device that does not belong to the irrigation system. In some embodiments, the device that does not belong to the irrigation system may be substantially any device that can capture the image of the property and plant on the property to be watered. Referring to FIG. 11, the irrigation system 100 may use the information/data provided by an image sensor 1102, e.g., belonging to the security or other system. For example, the image-capture device 1102 may be a security camera belonging to the door lock system.

In some embodiments, the irrigation system may include an image sensor 1104 communicatively coupled to the irrigation controller 102 and belonging to the irrigation control unit 101 in addition to or instead of the image sensor 1102 that does not belong to the irrigation system. In some embodiments, the image sensors 1102, 1104 may collect and/or generate imagery data from a detection area of the image sensors 1102, 1104 (e.g., an irrigation area of the property, or an area adjacent/related to the irrigation area of the property).

The image sensor 1104 communicatively coupled to the irrigation controller may transmit the captured image or video, and/or the imagery data to the irrigation controller. In some embodiments, the image sensors 1102, 1104 may transmit the imagery data illustrating at least one of feature, characteristic, condition, or status of the detected area or plants/objects on the detected area. In some embodiments, the imagery data provided by the image sensors 1002, 1004 may be used to know property conditions and plants conditions related to the irrigation such as wetness of property (e.g., whether the property is dry, wet, soaked), runoff of water to pavement/areas surrounding the plants being irrigated, rain event, watering by the emitters, viridity of plants, etc. Further, the irrigation system 100 may adjust the irrigation schedule using the imagery data provided by the image sensors 1102, 1104.

In some embodiments, the imagery data may be used to verify the flow data analysis result or enhance the precision of the flow data analysis by the data analysis unit 121. For example, the irrigation system may detect that sprinklers in a specific area are running by analyzing the imagery data received from the image sensors 1102, 1104.

In some embodiments, the data analysis unit (image analysis unit) 121 may use the imagery data in analyzing the measured flow data. For example, the data analysis unit 121 may use the shared image information/imagery data in verifying its analysis result. For example, if the flow data analysis result without the imagery data is consistent with the irrigation event learned from the imagery data, the data analysis unit (the image analysis unit) 121 may keep the analysis result. By contrast, if the flow data analysis result is not consistent with the information learned from the imagery data, the data analysis unit 121 may discard the analysis result. Further, the data analysis unit 121 may use the imagery data to reduce the number of unknown factors such that the precision of the analysis may be improved.

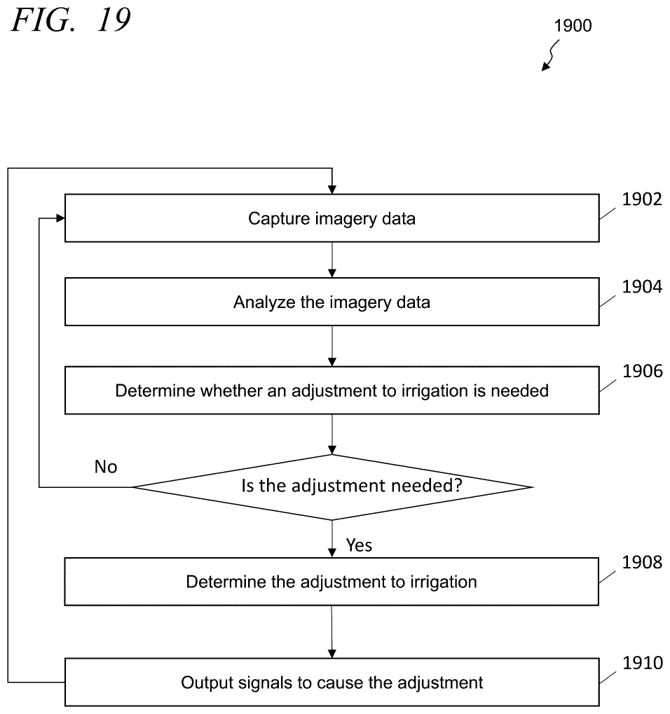

Referring to FIG. 19, in step 1902, one or more image sensors 1102, 1104 may capture, collect, and/or generate imagery data. The imagery data may be corresponding to a portion of an area of the property (e.g., a portion of the irrigation area of the property) or an area adjacent/related to the irrigation area of the property (e.g., a road or a street adjacent to the irrigation area of the property). The one or more image sensors 1102, 1104 may comprise at least one of a 2D camera, a 3D camera, a thermal camera, a video recorder, and an airborne camera.

In some embodiments, the imagery data may represent and/or illustrate one or more conditions/status of the area detected by the image sensors 1102, 1104. In some embodiments, the imagery data may comprise a visual representation of data from the image sensor. The visual representation of the data from the image sensor may be derived from the data from the image sensor. In some embodiments, the imagery data may include, but is not limited to, a photographic image, black and white photo images, color images, thermal image, 3D images, video, or other types of imagery data that can represent and/or illustrate at least one of feature, characteristic, condition, or status of the detected area or plants/objects on the detected area.

In some embodiments, the image sensors 1102, 1104 may comprise a camera communicatively coupled to the irrigation controller 102 executing the irrigation schedule. In some embodiments, the image sensors may comprise a camera communicatively coupled to a remote device. In some embodiments, the remote device may communicate to the irrigation controller 102 executing the irrigation schedule. In some embodiments, the remote device may comprise at least one of a server 135, a user computing devices 132 such as a computer, a mobile tablet, and a mobile phone, and a supervisory irrigation controller 137. In some embodiments, the remote device may communicate to another remote device comprising a computer, a mobile tablet, and a mobile phone, and a supervisory irrigation controller 137. In some embodiments, least one of the remote device and the another remote device may comprise a data analysis unit 121 and perform step 1904 with the data analysis unit 121.

In step 1904, the data analysis unit (image analysis unit) 121 may analyze the imagery data. In some embodiments, the data analysis unit 121 may analyze the imagery data to determine that irrigation is extending to an area not intended to receive the irrigation. To determine whether the irrigation is extending to the area not intended to be watered, the data analysis unit 121 may detect, using the imagery data, water leaking or wetting at the area not intended to receive the irrigation. In some embodiments, the data analysis unit 121 may analyze the imagery data to determine that excess irrigation is being applied. To determine whether the excess irrigation is applied, the data analysis unit 121 may detect, using the imagery data, water is flooded to an area not intended to receive the irrigation or the amount of water not absorbed by the soil of the irrigation area. In some embodiments, the data analysis unit 121 may analyze the imagery data to detect a phenomenon that could increase the humidity or indicate the increased humidity. The humidity increasing phenomenon may include, but is not limited to, rainfall, fog, storm, snowfall, dew formation, cloud formation, etc. In some embodiments, the data analysis unit 121 may analyze the imagery data to detect a plant condition or a soil condition that requires additional irrigation. For example, the plant condition that requires additional irrigation may include but not limited to wilting leaves, dropping of leaves, flowers, or fruits, discoloration, leaf curling, etc. The soil condition that requires additional irrigation may include but not limited to fast-draining soil, soil pulling away, soil color brighter than normal condition, etc. In some embodiments, the analyzing of the imagery data may be performed over time to learn patterns useful in the determining step.

In some embodiments, the analyzing of the imagery data is provided using a trained machine learning model 1210. In some embodiments, the trained machine learning model 1210 may comprise a trained machine learning algorithm configured to identify objects and conditions of the objects via artificial intelligence. In some embodiments, imagery data captured by the image sensor 1102, 1104 and imagery data from other sources such as online images, customer-captured images, customer-provided images, etc. may be used to train the machine learning model 1210.

In step 1906, the data analysis unit 121 may determine whether an adjustment to irrigation is needed based on the data analyzed in step 1904. When the data analysis unit 121 determines that the adjustment to irrigation is needed, in step 1908, the data analysis unit 121 may determine the adjustment to irrigation. The adjustment to the irrigation may include shutting off the irrigation, starting irrigation, reducing irrigation, and/or increasing irrigation. Then in step 1910, the data analysis unit 121 may output signals to cause the adjustment to be implemented. In some embodiments, the outputting the signals may comprise outing signals to automatically shut off or reduce the irrigation in response to detection of phenomenon that could increase the humidity or indicate the increased humidity, detection of excess irrigation, and/or detection of irrigation extended to the area not intended to revie the irrigation. In some embodiments, the outputting the signals may comprise outing signals to automatically start irrigation and/or add additional irrigation to the irrigation schedule in response to detection of the plant condition or the soil condition that requires additional irrigation.

When the data analysis unit 121 determines that the adjustment to irrigation is not needed, the flow for the method 1900 may go back to step 1902 and the following steps may be repeated. Steps 1902-1910 may be repeated as many times as needed.

In some embodiments, the analyzing data such as steps 1408, 1506, 1606, 1904 and/or the determining irrigation schedules, changes and/or adjustments such as steps 1410, 1508, 1608, 1706, 1906, 1908 may be provided using an algorithm and/or the trained machine learning model 1210. Data is analyzed in a real-world system, not a theoretical system.

The following patent documents are incorporated in their entirety herein by reference:
U.S. patent application Ser. No. 17/242,253, filed on Apr. 27, 2021, titled IRRIGATION FLOW SENSOR SYSTEMS AND METHODS OF DETECTING IRRIGATION FLOW (Docket No. 8473-152043-US); and
U.S. Pat. No. 11,477,950, granted on Oct. 25, 2022, titled VOLUMETRIC BUDGET BASED IRRIGATION CONTROL (Docket No. 8473-152160-US).

In some embodiments, a method of controlling irrigation may comprise receiving, at a server via a communication network, water flow data obtained from a flow meter and corresponding to a water usage at a first property, receiving, at the server via the communication network, sensor data obtained from one or more sensors at the first property, wherein the one or more sensors comprise at least one of a soil moisture sensor, a rain sensor, a temperature sensor, a wind sensor, a humidity sensor, and an image sensor, analyzing the water flow data and the sensor data, determining, based on the analyzed water flow data and the sensor data, at least one of an irrigation schedule to be executed at a second property and a change to an existing irrigation schedule to be executed at the second property, and outputting signals to implement the irrigation schedule or cause the change to the existing irrigation schedule.

In some embodiments, the first property is nearby the second property. In some embodiments, the first property and the second property are in a common geographic area and have similar landscape characteristics. In some embodiments, the first property is owned by a first entity and the second property is owned by a second entity, and further comprising obtaining, from the first entity, a consent to share the water flow data and the sensor data. In some embodiments, the method further comprises obtaining, from the first entity, a consent to use the shared water flow data and the sensor data to determine the at least one of the irrigation schedule to be executed at the second property and the change to the existing irrigation schedule to be executed at the second property. In some embodiments, the first property is owned by a first entity and the second property is owned by a second entity, and further comprising obtaining, from the second entity, a consent that an irrigation system can implement the irrigation schedule or cause the change to the existing irrigation schedule. In some embodiments, the method further comprises: transmitting, from the flow meter to an irrigation controller at the first property, the water flow data; transmitting, from the one or more sensors to the irrigation controller at the first property, the sensor data; and transmitting, from the irrigation controller to the server, the water flow data and the sensor data. In some embodiments, the method further comprises: transmitting, from the flow meter to a communication hub, the water flow data; transmitting, from the one or more sensors to the communication hub, the sensor data; and transmitting, from the communication hub to the server, the water flow data and the sensor data. In some embodiments, the communication hub is at the first property. In some embodiments, the communication hub is not at the first property. In some embodiments, the method further comprises: transmitting, from the flow meter to a first communication hub, the water flow data; transmitting, from the one or more sensors to a second communication hub, the sensor data; transmitting, from the first communication hub to the server, the water flow data; and transmitting, from the second communication hub to the server, the sensor data. In some embodiments, at least one of the first communication hub and the second communication hub is at the first property. In some embodiments, at least one of the first communication hub and the second communication hub is not at the first property. In some embodiments, the communication network is an internet network. In some embodiments, the one or more sensors are a private sensor. In some embodiments, the second property does not have sensors corresponding to the one or more sensors at the first property. In some embodiments, the second property does not have a flow meter configured to collect and transmit water flow data to the server. In some embodiments, the method further comprises prompting a user to enter a user input to collect the sensor data using the one or more sensors. In some embodiments, the one or more sensors comprises an image sensor of a mobile electronic device and, and further comprising prompting a user to take an image using the mobile electronic device to collect the sensor data. And in some embodiments, the image sensor is configured to collect imagery data from an irrigation area of the first property.

In some embodiments, a system for controlling irrigation comprise a server configured to receive, via a communication network, water flow data obtained from a flow meter and corresponding to a water usage at a first property, and configured to receive sensor data obtained from one or more sensors at the first property, wherein the one or more sensors comprise at least one of a soil moisture sensor, a rain sensor, a temperature sensor, a wind sensor, a humidity sensor, and an image sensor, wherein the server comprises a data analysis unit configured to analyze the water flow data and the sensor data, determine, based on the analyzed water flow data and the sensor data, at least one of an irrigation schedule to be executed at a second property and a change to an existing irrigation schedule to be executed at the second property, and output signals to implement the irrigation schedule or cause the change to the existing irrigation schedule. In some embodiments, the system further comprises an irrigation control unit configured to execute the irrigation schedule or the change in the irrigation schedule to cause irrigation at the second property.

In some embodiments, a method of controlling irrigation may comprise receiving, from a flow meter, water flow data corresponding to non-irrigation water usage at a property, wherein the property has one or more water emitters for irrigation of an area at the property, analyzing the water flow data, determining, based on the analyzed water flow data, a change to an existing irrigation schedule, the change being a shifting in time of a scheduled irrigation of the existing irrigation schedule, and outputting signals to cause a shift in the time of the scheduled irrigation of the existing irrigation schedule.

In some embodiments, the determining the change is further based on a non-irrigation water use pattern over a period of time. In some embodiments, the period of time comprises at least one of a daily period or weekly period. In some embodiments, the analyzing the water flow data includes identifying one or more non-irrigation water usage activities. In some embodiments, the change is determined based on a priority of the one or more non-irrigation water usage activities. In some embodiments, the priority of the one or more non-irrigation water usage activities is defined by a user associated with the property and/or an authorized party. In some embodiments, the property includes a structure having an indoor area intended for occupation by at least one person, and the non-irrigation water usage comprises an indoor water usage that has a higher priority than an irrigation water usage. In some embodiments, the property is a residential property having a residence home, and the non-irrigation water usage comprises an in-home water usage that has a higher priority than an irrigation water usage. In some embodiments, the property is a commercial property having a commercial building, and the non-irrigation water usage comprises an in-building water usage that has a higher priority than an irrigation water usage. In some embodiments, the property is a residential property having a residence home and the step of outputting the signals comprises outputting the signals to cause the shift in time of the scheduled irrigation to one or more time slots where the non-irrigation water usage typically comprises no or minimal in-home water usage. In some embodiments, the method further comprises receiving user input information regarding one or more water consumption components connected with a water supply to the property. In some embodiments, the one or more water consumption components comprises at least one of a bathtub, a shower booth, a basin, a toilet, a sink, a dishwasher, a washing machine, or the one or more water emitters. In some embodiments, the step of outputting the signals comprises outputting the signals to cause the shift in time of the scheduled irrigation of the existing irrigation schedule without changing a watering amount of the scheduled irrigation. In some embodiments, the step of outputting the signals comprises outputting the signals to cause the shift in time of the scheduled irrigation of the existing irrigation schedule without changing a watering duration of the scheduled irrigation. In some embodiments, the property includes a plurality of irrigation zones, and the step of outputting the signals comprises outputting the signals to cause the shift in the time of the scheduled irrigation of the existing irrigation schedule for a subset of the plurality of irrigation zones. In some embodiments, the property includes a plurality of irrigation zones, and the step of outputting the signals comprises outputting the signals to cause the shift in time of the scheduled irrigation of the existing irrigation schedule for all of the plurality of irrigation zones. In some embodiments, the analyzing of the flow data is provided over time to learn patterns in non-irrigation water uses. In some embodiments, the analyzing of the flow data is provided using a trained machine learning model.

In some embodiments, a method of controlling irrigation may comprise receiving, from a plurality of flow meters, a plurality of water flow data, each water flow data corresponding to non-irrigation water usage at each property of a group of properties, wherein the each property has one or more water emitters for irrigation of an area at the property, analyzing the plurality of water flow data, determining, based on the analyzed plurality of water flow data, a change to at least one of the plurality of existing irrigation schedules for the group of properties, and outputting signals to cause the change to at least one of the plurality of existing irrigation schedules for the group of properties. In some embodiments, the step of outputting the signals comprises outputting signals to cause a shift in the time of a scheduled irrigation of at least one of the plurality of existing irrigation schedules. In some embodiments, the step of outputting the signals comprises outputting signals to cause a reduction in at least one of a watering amount and a watering duration of a scheduled irrigation of at least one of the plurality of existing irrigation schedules.

In some embodiments, a system for controlling irrigation may comprise an irrigation control unit configured to control irrigation using one or more water emitters at a property in order to irrigate an area of the property, a flow meter configured to obtain water flow data corresponding to non-irrigation water usage at the property, and a data analysis unit configured to receive the water flow data corresponding to the non-irrigation water usage at the property, analyze the water flow data, determine, based on the analyzed water flow data, a change to an existing irrigation schedule executed by the irrigation control unit, the change being a shifting in time of a scheduled irrigation of the existing irrigation schedule, and output signals to cause a shift in the time of the scheduled irrigation of the existing irrigation schedule.

In some embodiments, a method of controlling irrigation may comprise receiving, from a flow meter, water flow data corresponding to a water usage at a property, determining, based on the water flow data, that an irrigation controller executing an irrigation schedule at the property can cause activation of a plurality of irrigation stations at a same time, and outputting signals to cause the irrigation controller to cause the activation of the plurality of irrigation stations at the same time.

In some embodiments, the water flow data corresponds to a non-irrigation water usage at the property. In some embodiments, the method further comprises analyzing the water flow data to identify a non-irrigation water usage at the property. In some embodiments, the step of outputting the signals causes the irrigation controller to cause the plurality of irrigation stations to be activated during a period unscheduled for watering for an entirety of the plurality of irrigation stations according to an existing irrigation schedule. In some embodiments, the step of outputting the signals causes the irrigation controller to cause the plurality of irrigation stations to be activated during a period when watering is not scheduled for a subset of the plurality of irrigation stations while watering is scheduled for at least one other irrigation stations of the plurality of irrigation stations according to an existing irrigation schedule. In some embodiments, the water flow data corresponds to an irrigation water usage at the property and a non-irrigation water usage at the property. In some embodiments, the irrigation schedule is not programmed for the activation of the plurality of irrigation stations at the same time. In some embodiments, the irrigation schedule is programmed to only activate one of the plurality of irrigation stations at a time.

In some embodiments, a system for controlling irrigation may comprise a flow meter configured to obtain water flow data corresponding to a water usage at a property, the property having one or more water emitters configured to irrigate an area of the property, and a data analysis unit configured to receive the water flow data corresponding to the water usage at the property, determine, based on the water flow data, that an irrigation control unit executing an irrigation schedule at the property can cause activation of a plurality of irrigation stations at a same time, and output signals to cause the irrigation control unit to cause the activation of the plurality of irrigation stations at the same time.

In some embodiments, a method of controlling irrigation may comprise providing, to a water authority, a consent that an irrigation schedule to be executed at a property will be provided by the water authority in exchange for a reduction of an obligation to the water authority, providing, to the water authority, water flow data obtained from a flow meter and corresponding to a water usage at the property, receiving, from the water authority, at least one of an irrigation schedule for execution at the property and an adjustment of an existing irrigation schedule for execution at the property, and outputting signals to cause implementation of at least one of the irrigation schedule and the adjustment.

In some embodiments, the step of outputting the signals to cause the implementation of at least one of the irrigation schedule and the adjustment is automatically performed. In some embodiments, the step of outputting the signals to cause the implementation of at least one of the irrigation schedule and the adjustment is automatically performed in response to reception of the at least one of the irrigation schedule for execution at the property and the adjustment of the existing irrigation schedule for execution at the property. In some embodiments, the reduction of the obligation to the water authority comprises one or more of a billing reduction, a rebate, a credit, billing in a different tier, and billing for a different volume of water use. In some embodiments, the step of providing the consent is responsive to an offer provided by the water authority. In some embodiments, the step of outputting the signals to cause the implementation comprises outputting signals to cause a shift in time of a scheduled irrigation of the existing irrigation schedule. In some embodiments, the step of outputting the signals to cause the implementation comprises outputting signals to cause a shift in time of a scheduled irrigation of the existing irrigation schedule to one or more time slots where anticipated water usage from the water authority is lower than a threshold capacity value. In some embodiments, the step of outputting the signals to cause the implementation comprises outputting signals to cause a reduction in at least one of a watering amount and a watering duration of a scheduled irrigation of the existing irrigation schedule. In some embodiments, the at least one of the irrigation schedule for execution at the property and the adjustment of the existing irrigation schedule for execution at the property is determined based on the water flow data obtained from the flow meter and corresponding to the water usage at the property. In some embodiments, the at least one of the irrigation schedule for execution at the property and the adjustment of the existing irrigation schedule for execution at the property is determined based on the water flow data obtained from the flow meter and corresponding to the water usage at the property and additional water flow data corresponding to water usage at one or more additional properties. In some embodiments, water to the property and the one or more additional properties is supplied by the water authority. In some embodiments, water to the property and the one or more additional properties is supplied via a common conduit.

In some embodiments, a system for controlling irrigation may comprise a user interface device configured to provide a consent to a water authority that an irrigation schedule to be executed at a property will be provided by the water authority in exchange for a reduction of an obligation to the water authority, a flow meter located at the property and configured to provide to the water authority water flow data corresponding to a water usage at the property, and an irrigation control unit configured to control irrigation using one or more water emitters at the property in order to irrigate an area of the property, wherein the irrigation control unit is configured to receive from the water authority at least one of an irrigation schedule for execution at the property and an adjustment of an existing irrigation schedule for execution at the property, and output signals to cause implementation of at least one of the irrigation schedule and the adjustment.

In some embodiments, the irrigation control unit is configured to automatically output, in response to reception of the at least one of the irrigation schedule for execution at the property and the adjustment of the existing irrigation schedule for execution at the property, the signals to cause the implementation of at least one of the irrigation schedule and the adjustment. In some embodiments, the reduction of the obligation to the water authority comprises one or more of a billing reduction, a rebate, a credit, billing in a different tier, and billing for a different volume of water use. In some embodiments, the irrigation control unit is configured to output the signals to cause a shift in time of a scheduled irrigation of the existing irrigation schedule. In some embodiments, the irrigation control unit is configured to output the signals to cause a shift in time of a scheduled irrigation of the existing irrigation schedule to one or more time slots where anticipated water usage from the water authority is lower than a threshold capacity value. In some embodiments, the irrigation control unit is configured to output the signals to cause a reduction in at least one of a watering amount and a watering duration of a scheduled irrigation of the existing irrigation schedule. In some embodiments, the at least one of the irrigation schedule for execution at the property and the adjustment of the existing irrigation schedule for execution at the property is determined based on the water flow data obtained from the flow meter and corresponding to the water usage at the property. In some embodiments, the at least one of the irrigation schedule for execution at the property and the adjustment of the existing irrigation schedule for execution at the property is determined based on the water flow data obtained from the flow meter and corresponding to the water usage at the property and additional water flow data corresponding to water usage at one or more additional properties.

In some embodiments, a method of controlling irrigation may comprise obtaining, from an image sensor, imagery data corresponding to a portion of an area of a property as it is being irrigated in accordance with an irrigation schedule, analyzing the imagery data, determining that an adjustment to irrigation is needed, and outputting signals to cause the adjustment to be implemented.

In some embodiments, the step of analyzing the imagery data comprises analyzing the imagery data to determine that irrigation is extending to an area not intended to receive the irrigation. In some embodiments, the step of analyzing the imagery data comprises analyzing the imagery data to determine that excess irrigation is being applied. In some embodiments, the step of analyzing the imagery data comprises analyzing the imagery data to detect a humidity increasing phenomenon. In some embodiments, the step of outputting the signals comprises outputting signals to automatically shut off, in response to detection of the humidity increasing phenomenon, the irrigation. In some embodiments, the step of analyzing the imagery data comprises analyzing the imagery data to detect a plant condition that requires additional irrigation to be applied. In some embodiments, the step of outputting the signals comprises outputting signals to add additional irrigation to the irrigation schedule. In some embodiments, the image sensor comprises a camera communicatively coupled to an irrigation controller. In some embodiments, the image sensor comprises an airborne camera. In some embodiments, the image sensor comprises a camera communicatively coupled to a remote device. In some embodiments, the remote device is configured to communicate to an irrigation controller executing the irrigation schedule and comprises at least one of a server, a computer, a mobile tablet, a mobile phone, and a supervisory irrigation controller. In some embodiments, the remote device is configured to communicate to another remote device comprising at least one of a server, a computer, a mobile tablet, a mobile phone, and a supervisory irrigation controller. In some embodiments, the imagery data comprises a photographic image. In some embodiments, the imagery data comprises a video. In some embodiments, the imagery data comprises a visual representation of data from the image sensor. In some embodiments, the visual representation of the data from the image sensor is derived from the data from the image sensor. In some embodiments, the analyzing of the imagery data is performed over time to learn patterns useful in the determining step. In some embodiments, the analyzing of the imagery data is provided using a trained machine learning model. In some embodiments, the obtaining steps comprises obtaining, from an image sensor and via a server, the imagery data corresponding to the portion of the area of the property as it is being irrigated in accordance with an irrigation schedule.

In some embodiments, a system for controlling irrigation may comprises an image sensor configured to capture imagery data from a portion of an area of a property as it is being irrigated using one or more water emitters in accordance with an irrigation schedule executed by an irrigation control unit, and a data analysis unit configured to analyze the imagery data, determine that an adjustment to irrigation is needed, and output signals to an irrigation control unit to cause the adjustment to be implemented.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. A method of controlling irrigation, the method comprising:
providing, to a water authority, a consent that an irrigation schedule to be executed at a property will be provided by the water authority in exchange for a reduction of an obligation to the water authority;
providing, to the water authority, water flow data obtained from a flow meter and corresponding to a water usage at the property;
receiving, from the water authority, at least one of an irrigation schedule for execution at the property and an adjustment of an existing irrigation schedule for execution at the property; and
outputting signals to cause implementation of at least one of the irrigation schedule and the adjustment.

2. The method of claim 1, wherein the step of outputting the signals to cause the implementation of at least one of the irrigation schedule and the adjustment is automatically performed.

3. The method of claim 1, wherein the step of outputting the signals to cause the implementation of at least one of the irrigation schedule and the adjustment is automatically performed in response to reception of the at least one of the irrigation schedule for execution at the property and the adjustment of the existing irrigation schedule for execution at the property.

4. The method of claim 1, wherein the reduction of the obligation to the water authority comprises one or more of a billing reduction, a rebate, a credit, billing in a different tier, and billing for a different volume of water use.

5. The method of claim 1, wherein the step of providing the consent is responsive to an offer provided by the water authority.

6. The method of claim 1, wherein the step of outputting the signals to cause the implementation comprises outputting signals to cause a shift in time of a scheduled irrigation of the existing irrigation schedule.

7. The method of claim 1, wherein the step of outputting the signals to cause the implementation comprises outputting signals to cause a shift in time of a scheduled irrigation of the existing irrigation schedule to one or more time slots where anticipated water usage from the water authority is lower than a threshold capacity value.

8. The method of claim 1, wherein the step of outputting the signals to cause the implementation comprises outputting signals to cause a reduction in at least one of a watering amount and a watering duration of a scheduled irrigation of the existing irrigation schedule.

9. The method of claim 1, wherein the at least one of the irrigation schedule for execution at the property and the adjustment of the existing irrigation schedule for execution at the property is determined based on the water flow data obtained from the flow meter and corresponding to the water usage at the property.

10. The method of claim 1, wherein the at least one of the irrigation schedule for execution at the property and the adjustment of the existing irrigation schedule for execution at the property is determined based on the water flow data obtained from the flow meter and corresponding to the water usage at the property and additional water flow data corresponding to water usage at one or more additional properties.

11. The method of claim 10, wherein water to the property and the one or more additional properties is supplied by the water authority.

12. The method of claim 10, wherein water to the property and the one or more additional properties is supplied via a common conduit.

13. A system for controlling irrigation comprising:
a user interface device configured to provide a consent to a water authority that an irrigation schedule to be executed at a property will be provided by the water authority in exchange for a reduction of an obligation to the water authority;
a flow meter located at the property and configured to provide to the water authority water flow data corresponding to a water usage at the property; and
an irrigation control unit configured to control irrigation using one or more water emitters at the property in order to irrigate an area of the property, wherein the irrigation control unit is configured to:
receive from the water authority at least one of an irrigation schedule for execution at the property and an adjustment of an existing irrigation schedule for execution at the property; and
output signals to cause implementation of at least one of the irrigation schedule and the adjustment.

14. The system of claim 13, wherein the irrigation control unit is configured to automatically output, in response to reception of the at least one of the irrigation schedule for execution at the property and the adjustment of the existing irrigation schedule for execution at the property, the signals to cause the implementation of at least one of the irrigation schedule and the adjustment.

15. The system of claim 13, wherein the reduction of the obligation to the water authority comprises one or more of a billing reduction, a rebate, a credit, billing in a different tier, and billing for a different volume of water use.

16. The system of claim 13, wherein the irrigation control unit is configured to output the signals to cause a shift in time of a scheduled irrigation of the existing irrigation schedule.

17. The system of claim 13, wherein the irrigation control unit is configured to output the signals to cause a shift in time of a scheduled irrigation of the existing irrigation schedule to one or more time slots where anticipated water usage from the water authority is lower than a threshold capacity value.

18. The system of claim 13, wherein the irrigation control unit is configured to output the signals to cause a reduction in at least one of a watering amount and a watering duration of a scheduled irrigation of the existing irrigation schedule.

19. The system of claim 13, wherein the at least one of the irrigation schedule for execution at the property and the adjustment of the existing irrigation schedule for execution at the property is determined based on the water flow data obtained from the flow meter and corresponding to the water usage at the property.

20. The system of claim 13, wherein the at least one of the irrigation schedule for execution at the property and the adjustment of the existing irrigation schedule for execution at the property is determined based on the water flow data obtained from the flow meter and corresponding to the water usage at the property and additional water flow data corresponding to water usage at one or more additional properties.
